(19) United States
(12) Patent Application Publication
(10) Pub. No.: US 2023/0295436 A1
(43) Pub. Date: Sep. 21, 2023

(54) INTERMOLECULARLY-FABRICATED COMPOSITION FOR ENCAPSULATING PLANT MATERIALS, AGROCHEMICALS AND PHARMACEUTICALS

(71) Applicant: University of Central Florida Research Foundation, Inc., Orlando, FL (US)

(72) Inventors: Jorge Pereira, Orlando, FL (US); Giuliana Gan Giannelli, Winter Park, FL (US); Edwin Davidson, Orlando, FL (US); Swadeshmukul Santra, Oviedo, FL (US); Sebastian Leon, Orlando, FL (US)

(73) Assignee: University of Central Florida Research Foundation, Inc., Orlando, FL (US)

(21) Appl. No.: 18/121,401

(22) Filed: Mar. 14, 2023

Related U.S. Application Data
(60) Provisional application No. 63/319,824, filed on Mar. 15, 2022.

(51) Int. Cl. C08L 101/00; C08K 5/1545

(52) U.S. Cl. CPC C08L 101/00; C08K 5/1545; C08L 2203/02

(57) ABSTRACT

This disclosure relates to an intermolecularly-fabricated composition for capturing plant materials, agrochemicals and pharmaceuticals which can simultaneously capture inorganic particulates and organic compounds in which the capture materials have mutual chemical affinity with the composition matrix thereby exhibiting an adhesive property.

### CROSS-REFERENCE TO RELATED APPLICATIONS

This application claims priority to U.S. Provisional Patent Application No. 63/319,824, filed Mar. 15, 2022. The contents of this application are incorporated herein by reference in its entirety.

### FIELD

This disclosure relates to an intermolecularly-fabricated composition for capturing and encapsulating plant materials, agrochemicals and pharmaceuticals in a submicron size chemical matrix which can simultaneously capture inorganic particulates and organic compounds in which the capture materials have mutual chemical affinity with the composition matrix thereby exhibiting an adhesive property.

### BACKGROUND

The encapsulation of agrochemicals and pharmaceutical active ingredients is important for maintaining these materials in their original forms and conditions and in a biological environment prior to interaction with a target. Loss of activity of agricultural and pharmaceutical active ingredients prior to reaching their intended target is a significant problem for the industry. In particular, loss of activity and bioavailability resulting from photo-degradation or other forms of chemical and biological degradation prior to administration of such materials to a target have a dramatic effect on the efficacy of the application, for example, decreased efficiency of pesticides and fertilizers, and disruptions in disease management.

As such, a need exists for an improved means to stabilize active ingredients for later use without experiencing significant loss in activity during storage or resulting from a biological environment. The present disclosure provides a solution for this need.

To that end, disclosed is an intermolecularly-fabricated composition to capture inorganic particulates (hard materials) and organic molecules (soft materials) simultaneously through mutually-attractive chemical affinity (adhesive property). The compositions utilize the unique adhesive property among all chemicals (inorganic, organic and polymeric materials) originated through hydrophobic bonds (such as Pi-Pi, Pi-sigma or a combination of the two) and hydrophilic bonds (such as hydrogen bonding and proton/electron transfer) to provide a cost-effective composition for capturing and protecting a variety of active ingredients (such as agrochemicals, pharmaceuticals or any combination thereof) in stable submicron size particles as a commercially viable product formulation.

### SUMMARY OF THE INVENTION

In one aspect, the invention provides an intermolecularly-fabricated composition comprising one or more active ingredients, a polyphenol component and a polymeric stabilizer wherein the polyphenol component and the polymeric stabilizer capture the active ingredient in a chemical matrix.

In some embodiments of the intermolecularly-fabricated composition of the invention, \the active ingredient is an agrochemical, a fertilizer, a biostimulant, a pesticide, a pharmaceutical, a reactive chemical products, a food product, a beverage product, or combinations thereof.

In particular embodiments of the intermolecularly-fabricated composition of the invention, the active ingredient is a urea compound, a silicon compound, or a polyphenol compound; oxytetracycline; curcumin, creatine or dopamine, or a combination thereof; or caffeine, a food or beverage stabilizing agent, a food or beverage flavoring agent, or a combination thereof.

In other embodiments of the intermolecularly-fabricated composition of the invention, the polyphenol component is a flavonoid, a flavone, a flavonol, a flavanol, a flavanone, an isoflavone, a proanthocyanidin, a anthocyanin, a phenolic acid, a phenolic amine, a stilbene, a lingnian, or a combination thereof.

In particular embodiments of the intermolecularly-fabricated composition of the invention, polyphenol component is tannic acid, catechin, hesperetin (, cyanidin, daidzein, quercetin, caffeic acid, reservatrol, ellagic acid, or a combination thereof. In specific embodiments of the intermolecularly-fabricated composition of the invention, the polyphenol component is tannic acid.

In other embodiments of the intermolecularly-fabricated composition of the invention, the polymeric stabilizer is a thermoplastic polymer, a biodegradeable polymer, a hydrophobic polymer, a hydrophilic polymer, a co-polymer consisting of hydrophobic and hydrophilic components, or a combination thereof.

In another aspect, the invention provides a method of stabilizing an active ingredient comprising capturing the active ingredient in an intermolecularly-fabricated composition comprising the active ingredient, a polyphenol component and a polymeric stabilizer to form a formulated active ingredient and storing the formulated active ingredient in a storage medium;

wherein the polyphenol component and the polymeric stabilizer capture the active ingredient in a chemical matrix.

In some embodiments of the method of stabilizing an active ingredient of the invention, the active ingredient is an agrochemical, a fertilizer, a biostimulant, a pesticide, a pharmaceutical, a reactive chemical products, a food product, a beverage product, or combinations thereof.

In another aspect, the invention provides a method of increasing the shelf-life of an active ingredient comprising capturing the active ingredient in an intermolecularly-fabricated composition comprising the active ingredient, a polyphenol component and a polymeric stabilizer to form a formulated active ingredient and storing the formulated active ingredient in a storage medium;

wherein the polyphenol component and the polymeric stabilizer capture the active ingredient in a chemical matrix such that the shelf-life of the active ingredient is increased by at least two months as compared to a non-formulated form of the same active ingredient in the same storage medium.

In some embodiments of the method of increasing the shelf-life of an active ingredient of the invention, wherein the active ingredient is an agrochemical, a fertilizer, a biostimulants, a pesticide, a pharmaceutical, a reactive chemical products, a food product, a beverage product, or combinations thereof.

In another aspect, the invention provides a method of delivering an active ingredient to a subject, the method comprising:
capturing the active ingredient in an intermolecularly-fabricated composition comprising the active ingredient, a polyphenol component and a polymeric stabilizer;
and administering the intermolecularly-fabricated composition to the subject.

In certain embodiments of the method of delivering an active ingredient to a subject of the invention, the method further comprising a step of formulating the intermolecularly-fabricated composition with one or solvents, carriers, adjuvants, or excipients acceptable for administration to the subject.

In some embodiments of the method of delivering an active ingredient to a subject of the invention, the active ingredient is an agrochemical, a fertilizer, a biostimulant, a pesticide, a pharmaceutical, a reactive chemical products, a food product, a beverage product, or combinations thereof.

In still other embodiments of the method of delivering an active ingredient to a subject of the invention, wherein the subject is a human, an animal, a plant-based organism, a food product, or a beverage product.

### BRIEF DESCRIPTION OF THE DRAWINGS

FIG. 1. Hydrodynamic size distribution of the NPs measured by DLS. Histograms (A) and (B) show the size distributions of Cur-TA-PVP and TA-PVP NPs, respectively.

FIG. 2. SEM images of optimized formulations of (A) Cur-TA-PVP and (B) TA-PVP NPs. Both samples are comprised of spherical NPs. The images also demonstrate the bimodal size distribution suggested by the DLS data, as shown in FIG. 1.

FIG. 3. The UV-visible spectrum of Cur-TA-PVP NPs to identify and confirm the components that make up the curcumin NP system. The Cur-TA-PVP NPs have absorbance peaks at 212 nm, 275 nm, and 434 nm, which correspond to the absorbance peaks of each component used to synthesize the system.

FIG. 4. FTIR spectra of Cur-TA-PVP NPs, TA-PVP NPs, and free curcumin to identify chemical groups and any interactions thereof. The broad O—H stretching characteristic of TA, N—C═O bending peak characteristic of PVP, and phenolic O—H stretching peak characteristic of curcumin, collectively confirm the presence of the components introduced during synthesis within the NP system. Moreover, the phenolic O—H stretching peak shift from 3508 to 3650 cm-1 suggests the successful capture of stable curcumin into the NP.

FIG. 5. Fluorescence emission spectra of Cur-TA-PVP and free curcumin in water to determine the localization of curcumin in the NP. The blue shift in the peak emission, from 558 nm to 533 nm, indicates that curcumin exists in the hydrophobic core of the NP.

FIG. 6. Degradation of curcumin in water when encapsulated in TA-PVP and or in free form. Simple linear regression was performed to determine the slope of each data set, which are −0.01123 and −0.005019 for curcumin and Cur-TA-PVP, respectively; statistical analysis determined that the slopes are significantly different (p<0.0001) which suggests that the NP system dramatically reduces the degradation rate of curcumin.

FIG. 7. Release rate of curcumin from the NP. Results show gradual release of curcumin from the NP until a cumulative maximum release of 20% is achieved at 20 hours.

FIG. 8. DPPH radical scavenging activity to deduce antioxidant potential of treatments. Treatments were prepared to a final concentration corresponding to 5 μM of curcumin, and 5 μM of ascorbic acid (positive control). Data are represented as the mean±standard deviation (n=3). Statistical analysis was performed using one-way ANOVA (****p<0.0001).

FIG. 9. AlamarBlue viability assay of SH-SY5Y cells when treated with Cur-TA-PVP, TA-PVP, or free curcumin. Cells were incubated with the treatments for 24 hours, and then with media containing 10% resazurin for 2 hours. Fluorescence readings were acquired at an ex/em of 560/590 nm. The data are represented as the mean±standard deviation (n=3).

FIG. 10. AlamarBlue viability assay of J774 murine macrophages when treated with Cur-TA-PVP, TA-PVP, or free curcumin. Cells were incubated with the treatments for 24 hours, and then with media containing 10% resazurin for 2 hours. Fluorescence readings were acquired at an ex/em of 560/590 nm. The data are represented as the mean±standard deviation (n=3).

FIG. 11. AlamarBlue viability assay on S16 Rat Schwann Cells when treated with Cur-TA-PVP, TA-PVP, or free curcumin. Cells were incubated with the treatments for 24 hours, and then with media containing 10% resazurin for 2 hours. Fluorescence readings were acquired at an ex/em of 560/590 nm. The data are represented as the mean±standard deviation (n=3).

FIG. 12. Fluorescence microscopy images of curcumin (green channel) in SH-SY5Y (A, B), J774 macrophages (C, D), and S16 RSCs (E, F) to determine the relative concentration of curcumin in cells when administered in the encapsulated (A, C, E) or free form (B, D, F).

FIG. 13. Quantitative analysis of green fluorescence intensity in (A) SH-SY5Y cells, (B) S16 RSCs, and (C) J774 murine macrophages. The data are represented as mean±standard deviation (n=3). Statistical analysis was performed using one-way ANOVA (*p<0.05, **p<0.01, ***p<0.001, ****p<0.0001, ns not significant).

FIG. 14. 50 μM H₂O₂-induced oxidative stress and cell rescue by treatments on SH-SY5Y cells. Cells were pre-treated with Cur-TA-PVP, TA-PVP, or free curcumin for 6 hours, and then treated with fresh media containing 50 uM H₂O₂ for 18 hours. Cells were then treated with 10% resazurin for 2 hours, and fluorescence was read at an ex/em of 560/590 nm. There appears to be no protection against oxidative stress offered by any of the treatments. Data are represented as mean±standard deviation (n=3).

FIG. 15. 100 μM H₂O₂-induced oxidative stress and cell rescue by treatments on J774 murine macrophages. Cells were pre-treated with Cur-TA-PVP, TA-PVP, or free curcumin for 6 hours, and then treated with fresh media containing 100 uM H₂O₂ for 18 hours. Cells were then treated with 10% resazurin for 2 hours, and fluorescence was read at an ex/em of 560/590 nm. There appears to be some protection against oxidative stress when cells are treated with 10 μM of Cur-TA-PVP NPs. Data are represented as mean±standard deviation (n=3). A one-way ANOVA was performed to determine any statistically significant differences compared to the H₂O₂ control (**p<0.01)

FIG. 16. Dynamic light scattering plot showing the particle size distribution intensity of TA-PVP-Caffeine.

FIG. 17. SEM images of optimized formulations of TA-PVP-Caffeine.

FIG. 18. Dynamic light scattering plot showing the particle size distribution intensity of TA-PVP-Sesamol.

FIG. 19. SEM images of optimized formulations of TA-PVP-Sesamol.

FIG. 20. Dynamic light scattering plot showing the particle size distribution intensity of TA-PVP-RNA.

FIG. 21. Dynamic light scattering plot showing the particle size distribution intensity of TA-PVP-IAA.

FIG. 22. SEM images of optimized formulations of TA-PVP-IAA.

FIG. 23. Dynamic light scattering plot showing the particle size distribution intensity of TA-PVP-Cu²⁺.

FIG. 24. SEM images of optimized formulations of TA-PVP-Cu²⁺.

FIG. 25. Dynamic light scattering plot showing the particle size distribution intensity of TA-PVP-Zn²⁺.

FIG. 26. SEM images of optimized formulations of TA-PVP-Zn²⁺. FIG. 27. Dynamic light scattering plot showing the particle size distribution intensity of TA-PVP-SiO₂-Urea.

FIG. 28. FTIR Spectra of TA-PVP-SiO₂-Urea. The FTIR spectra suggests the presence of silica and urea in the final product through their signature peaks and band.

FIGS. 29A, 29B, and 29C. SEM images of optimized formulations of TA-PVP-SiO₂-Urea.

FIG. 30. Dynamic light scattering plot showing the particle size distribution intensity of TA-PVP-Creatine as well as a zeta potential distribution of TA-PVP-Creatine.

FIG. 31. SEM images of optimized formulations of TA-PVP-Creatine.

### DETAILED DESCRIPTION

In one aspect, this disclosure provides an intermolecularly-fabricated composition comprising one or more active ingredients, a polyphenol component and a polymeric stabilizer wherein the polyphenol component and the polymeric stabilizer capture the one or more active ingredients in a chemical matrix.

In another aspect, the disclosure provides a method of stabilizing an active ingredient comprising capturing the active ingredient in an intermolecularly-fabricated composition comprising the active ingredient, a polyphenol component and a polymeric stabilizer to form a formulated active ingredient and storing the formulated active ingredient in a storage medium;

wherein the polyphenol component and the polymeric stabilizer capture the active ingredient in a chemical matrix.

In still another aspect, the disclosure provides a method of increasing the shelf-life of an active ingredient comprising capturing the active ingredient in an intermolecularly-fabricated composition comprising the active ingredient, a polyphenol component and a polymeric stabilizer to form a formulated active ingredient and storing the formulated active ingredient in a storage medium;

wherein the polyphenol component and the polymeric stabilizer capture the active ingredient in a chemical matrix such that the shelf-life of the active ingredient is increased by at least two months as compared to a non-formulated form of the same active ingredient in the same storage medium.

Certain drawings are attached. For purposes of explanation and illustration, and not limitation, embodiments of an intermolecularly-fabricated composition in accordance with the disclosure are described herein with general reference to the attached drawings.

The following is a detailed description provided to aid those skilled in the art in practicing the present disclosure. Those of ordinary skill in the art may make modifications and variations in the embodiments described herein without departing from the spirit or scope of the present disclosure. All publications, patent applications, patents, figures, and other references mentioned herein are expressly incorporated by reference in their entirety.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either both of those included limits are also included in the disclosure.

All numerical values within the detailed description and the claims herein are modified by “about” or “approximately” the indicated value, and take into account experimental error and variations that would be expected by a person having ordinary skill in the art.

The following terms are used to describe the present disclosure. Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrases “at least one” and “one or more” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

“Capture” or “capturing” of active ingredients, as used herein, refers to the encapsulation, sequestration, supporting, embedding, coordination, aggregation, or immobilization of one or more active ingredients by or within the chemical matrix. In certain embodiments, the active ingredients are encapsulated by the chemical matrix. In other certain embodiments, the active ingredients are sequestered on the surface of the chemical matrix. In certain embodiments, the active ingredients may be fully or partially captured by the chemical matrix.

“Stabilize” or “Stabilizing” of active ingredients, as used herein, refers to the prevention or reduction of the degradation of the active ingredient, thereby maintaining its intended properties and efficacy during storage and use. In certain embodiments only specific properties of an active ingredient are stabilized. In some embodiments the degradation is slowed so as to be considered negligible.

“Shelf-life” of active ingredients, as used herein, refers to the duration of time during which a formulated active ingredient maintains its physical, chemical or biological properties, and remains effective for its intended use when stored under recommended storage conditions. In certain embodiments, the active ingredient's colloidal properties, particle size and particle surface charge are maintained. In other embodiments, the chemical structure of the active ingredient is maintained. In certain embodiments only the shelf-life of one or more active ingredients is maintained.

“Delivery” or “Delivering” of active ingredients, as used herein, refers to the method of administering or applying an active ingredient to a biological organism in a deliberate manner. In certain embodiments, the captured active ingredient can be delivered to plants, animals, humans or unicellular organisms. In other embodiments, the captured active ingredient can be delivered to cellular culture of biological organisms. In certain embodiments one or more active ingredients can be delivered to biological organisms.

“Active ingredient,” as used herein, include, but are not limited to, agrochemicals, pharmaceuticals, pesticides, fertilizers, nutraceuticals, and food and beverage products. Such active ingredients may benefit from use with the disclosed composition by increasing shelf-life, reducing photochemical and other chemical decomposition, and increasing ease of storage and/or administration. Such active ingredients can be in any form. In certain embodiments, the active ingredient can be a solid particulate, such as a whole or partial plant material. In certain embodiments one or more active ingredients can be captured in the same chemical matrix.

“Substantially” or “essentially” means nearly totally or completely, for instance, 95%, 96%, 97%, 98%, 99% or greater of some given quantity.

“Substantially free” refers to the nearly complete or complete absence of a given quantity for instance, less than about 10%, 5%, 4%, 3%, 2%, 1%, 0.5% or less of some given quantity. For example, certain compositions may be “substantially free” of cell proteins, membranes, nucleic acids, endotoxins, or other contaminants.

Where the plural form of the word compounds, salts, polymorphs, hydrates, solvates and the like, is used herein, this is taken to mean also a single compound, salt, polymorph, isomer, hydrate, solvate or the like.

The present disclosure also relates to useful forms of the compounds as disclosed herein, such as pharmaceutically acceptable salts, co-precipitates, metabolites, hydrates, solvates and prodrugs of all the compounds of examples. The term “pharmaceutically acceptable salt” refers to a relatively non-toxic, inorganic or organic acid addition salt of a compound of the present disclosure. For example, see S. M. Berge, et al. “Pharmaceutical Salts,” J. Pharm. Sci. 1977, 66, 1-19. Pharmaceutically acceptable salts include those obtained by reacting the main compound, functioning as a base, with an inorganic or organic acid to form a salt, for example, salts of hydrochloric acid, sulfuric acid, phosphoric acid, methane sulfonic acid, camphor sulfonic acid, oxalic acid, maleic acid, succinic acid and citric acid. Pharmaceutically acceptable salts also include those in which the main compound functions as an acid and is reacted with an appropriate base to form, e.g., sodium, potassium, calcium, magnesium, ammonium, and chorine salts. Those skilled in the art will further recognize that acid addition salts of the claimed compounds may be prepared by reaction of the compounds with the appropriate inorganic or organic acid via any of a number of known methods. Alternatively, alkali and alkaline earth metal salts of acidic compounds of the disclosure are prepared by reacting the compounds of the disclosure with the appropriate base via a variety of known methods.

The term “solvates” for the purposes of the disclosure are those forms of the compounds that coordinate with solvent molecules to form a complex in the solid or liquid state. Hydrates are a specific form of solvates, wherein the solvent is water.

Salts of the materials identified herein can be obtained by isolating the compounds as hydrochloride salts, prepared by treatment of the free base with anhydrous HCl in a suitable solvent such as THF. Generally, a desired salt of a compound of this disclosure can be prepared in situ during the final isolation and purification of a compound by means well known in the art. Or, a desired salt can be prepared by separately reacting the purified compound in its free base form with a suitable organic or inorganic acid and isolating the salt thus formed. These methods are conventional and would be readily apparent to one skilled in the art.

The compounds, compositions and materials according to the disclosure are preferably isolated in more or less pure form that is more or less free from residues from the synthetic procedure. The degree of purity can be determined by methods known to the chemist or pharmacist (see especially Remington's Pharmaceutical Sciences, 18^{th} ed. 1990, Mack Publishing Group, Enolo). Preferably the compounds are greater than 99% pure (w/w), while purities of greater than 95%, 90% or 85% can be employed if necessary.

Throughout this document, for the sake of simplicity, the use of singular language is given preference over plural language, but is generally meant to include the plural language if not otherwise stated. e.g., the expression “A method of treating a disease in a patient, comprising administering to a patient an effective amount of a compound of claim 1” is meant to include the simultaneous treatment of more than one disease as well as the administration of more than one compound of claim 1.

It should also be understood that, in certain methods described herein that include more than one step or act, the order of the steps or acts of the method is not necessarily limited to the order in which the steps or acts of the method are recited unless the context indicates otherwise.

### Intermolecularly Fabricated Composition

Certain embodiments include an intermolecularly-fabricated composition for capturing plant materials, agrochemicals, and pharmaceuticals. The said composition can simultaneously capture inorganic particulates and organic compounds in which the capture materials have mutual chemical affinity among themselves and to the composition matrix, exhibiting an adhesive property. The said property is mutually beneficial for the composition's structural stability and capture materials' chemical stability, which are critical for the product formulation and its commercialization.

Disclosed is an intermolecularly-fabricated composition to capture inorganic particulates (hard materials) and organic molecules (soft materials) simultaneously through mutually-attractive chemical affinity (adhesive property). The disclosed intermolecularly-fabricated composition utilizes a unique adhesive property among certain inorganic, organic and polymeric materials originated through hydrophobic (such as Pi-Pi, Pi-sigma and a combination of two) and hydrophilic (such as hydrogen bonding and proton/electron transfer) bonding. The disclosed intermolecularly-fabricated composition demonstrates self-aggregation of captured chemicals within a dispersible chemical matrix, resulting a core-shell ultra-small nanostructures embedded within a microscopic (sub-micron/micron size) gel-like counterparts. An example is the co-capture of nitrogen rich chemical (such as urea, ammonium phosphate or a combination thereof) and silicon (such as oxides of silicon, silicic acid, silicate) in their molecular and particulate forms within a dispersible chemical matrix made of polyphenols (such as plant-derived tannic acid) and polymeric stabilizers (such as polyvinyl pyrrolidone, polyvinyl alcohol, chitosan or any combination thereof).

The disclosed intermolecularly-fabricated composition utilizes a polyphenol component. Such polyphenol components include chemical synthetic and naturally occurring organic compounds characterized by multiples of phenol units. Polyphenol components for use herein include flavonoids, flavones, flavonols, flavanols, flavanones, isoflavones, proanthocyanidins, anthocyanins, phenolic acids, phenolic amines, stilbenes and lignans. Specific polyphenol components for use herein include, but are not limited to, tannic acid, catechin, hesperetin, cyanidin, daidzein, quercetin, caffeic acid, resveratrol, and ellagic acid. In particular embodiments, the polyphenol component is tannic acid.

The disclosed intermolecularly-fabricated composition utilizes a polymeric stabilizer. Such polymeric stabilizers include thermoplastic polymers, biodegradable polymers, hydrophobic polymers, and hydrophilic polymers and co-polymers consisting of hydrophobic and hydrophilic components.

Suitable thermoplastic polymers include, but are not limited to polylactides, polyglycolides, polycaprolactones, polyanhydrides, polyamides, polyurethanes, polyesteramides, polyorthoesters, polydioxanones, polyacetals, polyketals, polycarbonates, polyorthocarbonates, polyphosphazenes, polyhydroxybutyrates, polyhydroxyvalerates, polyalkylene oxalates, polyalkylene succinates, poly(malic acid) polymers, polymaleic anhydrides, poly(methylvinyl) ethers, poly(amino acids), chitin, chitosan, and copolymers, terpolymers, or combinations or mixtures of the above materials.

Examples of biodegradable polymers and oligomers suitable for use in the compositions and methods of the disclosure include, but are not limited to: poly(lactide)s; poly(glycolide)s; poly(lactide-co-glycolide)s; poly(lactic acid)s; poly(glycolic acid)s; and poly(lactic acid-co-glycolic acid)s; poly(caprolactone)s; poly(malic acid)s; polyamides; polyanhydrides; polyamino acids; polyorthoesters; polyetheresters; polycyanoacrylates; polyphosphazines; polyphosphoesters; polyesteramides; polydioxanones; polyacetals; polyketals; polycarbonates; polyorthocarbonates; degradable polyurethanes; polyhydroxybutyrates; polyhydroxyvalerates; polyalkylene oxalates; polyalkylene succinates; chitins; chitosans; oxidized celluloses; and copolymers, terpolymers, blends, combinations or mixtures of any of the above materials.

Hydrophilic polymers suitable for use herein can be obtained from various commercial, natural or synthetic sources well known in the art. Suitable hydrophilic polymers include, but are not limited to: polyanions including anionic polysaccharides such as alginate; agarose; heparin; polyacrylic acid salts; polymethacrylic acid salts; ethylene maleic anhydride copolymer (half ester); carboxymethyl amylose; carboxymethyl cellulose; carboxymethyl dextran; carboxymethyl starch; carboxymethyl chitin/chitosan; carboxy cellulose; 2,3-dicarboxycellulose; tricarboxycellulose; carboxy gum arabic; carboxy carrageenan; carboxy pectin; carboxy tragacanth gum; carboxy xanthan gum; carboxy guar gum; carboxy starch; pentosan polysulfate; curdlan; inositol hexasulfate; beta-cyclodextrin sulfate; hyaluronic acid; chondroitin-6-sulfate; dermatan sulfate; dextran sulfate; heparin sulfate; carrageenan; polygalacturonate; polyphosphate; polyaldehydo-carbonic acid; poly-1-hydroxy-1-sulfonate-propen-2; copolystyrene maleic acid; mesoglycan; sulfopropylated polyvinyl alcohols; cellulose sulfate; protamine sulfate; phospho guar gum; polyglutamic acid; polyaspartic acid; polyamino acids; and any derivatives or combinations thereof. One skilled in the art will appreciate other hydrophilic polymers that are also within the scope of the present invention.

Water-soluble polymers include, but are not limited to: poly (alkyleneglycol), polyethylene glycol (“PEG”); propylene glycol; ethylene glycol/propylene glycol copolymers; carboxylmethylcellulose; dextran; polyvinyl alcohol (“PVA”); polyvinyl pyrolidone; poly (alkyleneamine)s; poly (alkyleneoxide)s; poly-1,3-dioxolane; poly-1,3,6-trioxane; ethylene/maleic anhydride copolymers; polyaminoacids; poly (n-vinyl pyrolidone); polypropylene oxide/ethylene oxide copolymers; polyoxyethylated polyols; polyvinyl alcohol succinate; glycerine; ethylene oxides; propylene oxides; poloxamers; alkoxylated copolymers; water soluble polyanions; and any derivatives or combinations thereof. In addition, the water-soluble polymer may be of any suitable molecular weight, and may be branched or unbranched.

The disclosed intermolecularly-fabricated composition leads to a cost-effective composition for capturing and protecting a variety of active ingredients (such as agrochemicals, pharmaceuticals or any combination thereof) in a commercially viable product formulation. The relative ratio of the constituent chemicals in the composition can be customized to produce a stable suspension at ambient condition. The agriculture product formulation has strong affinity for plants (rainfastness), non-phytotoxic and environmentally friendly.

The disclosed intermolecularly-fabricated composition provides protection of agrochemical and pharmaceutical active ingredients in their original form in storage conditions as well as in biological environment (including plants and animals prior to interaction with the target).

The disclosed intermolecularly-fabricated composition can be broadly used to protect a wide variety of active ingredients, including but not limited to, pesticides, fertilizers, micronutrients, RNA, inorganic ions, and pharmaceuticals in a liquid or gel form. The disclosed intermolecularly-fabricated composition allows for an increase in the shelf-life of a given active ingredient for at least one month beyond the shelf-life of the non-formulated active ingredient in the same liquid or gel medium. In certain embodiments, the disclosed intermolecularly-fabricated composition allows for an increase in the shelf-life of a given active ingredient for at least 2 months, at least 3 months, at least 6 months, at least 9 months, at least 12 months, at least 18 months, or at least 24 months beyond the shelf-life of the non-formulated active ingredient in the same liquid or gel medium. In other embodiments, the shelf-life of the encapsulated/captured active ingredient is at least 3 months, at least 6 months, at least 9 months, at least 12 months, at least 18 months, or at least 24 months.

The disclosed intermolecularly-fabricated composition allows for storage of an encapsulated/captured active ingredient without experiencing any significant loss in activity during storage or in a biological environment prior to reaching the target.

The disclosed intermolecularly-fabricated composition can be broadly used to deliver a wide variety of active ingredients, including but not limited to, pesticides, fertilizers, micronutrients, RNA, inorganic ions, and pharmaceuticals in a liquid or gel form. In some embodiments, the disclosed intermolecularly-fabricated composition allows for an increase in cellular uptake of a given active ingredient.

Active ingredients which may be used with the disclosed intermolecularly-fabricated composition include agrochemicals, fertilizers (including macronutrients and micronutrients), biostimulants, pesticides, pharmaceuticals and reactive chemical products, food and beverage products. Specific active ingredients which may be stabilized by the disclosed intermolecularly-fabricated composition include urea, silicon, and polyphenol compounds. In certain embodiments the active ingredients may include both chemical synthetic ingredients and plant-derived ingredients. In certain embodiments the active ingredients may include RNA, sesamol, and/or inorganic ions.

In certain agricultural embodiments, the active ingredients include oxytetracycline which is useful for treating citrus greening disease. In a related aspect, the invention provides a method for treating citrus greening disease using an intermolecularly-fabricated composition of the invention.

In certain other biomedical embodiments, the active ingredients include curcumin, creatine and dopamine which are useful for treating neurological disorders, including but not limited to peripheral nerve injuries and traumatic brain injury. In a related aspect, the invention provides a method for treating a neurological disorder using an intermolecularly-fabricated composition of the invention.

In certain other food and beverage embodiments, the active ingredients include caffeine, stabilizing agents, and/or flavoring agents. In a related aspect, the invention provides a method for improving the stability and/or shelf life of a beverage using an intermolecularly-fabricated composition of the invention.

In certain embodiments, the intermolecularly-fabricated composition of the invention is in the form of one or more nanoparticles. The size of these nanoparticles will depend on the active ingredient being captured by the nanoparticle. The average particle size of such nanoparticles is generally between 100 nm and 1000 nm. In particular embodiments, the average particle size of such nanoparticles is between 150 nm and 500 nm. In still other embodiments, the average particle size of such nanoparticles is between 200 nm and 300 nm.

### EXAMPLES

### Example 1: A Composition Containing Nitrogen and Silicon—An Example of an Agrochemical Active Ingredient

Synthesis protocol: In a 250 mL conical flask, dissolve 25.0 g urea in 15 mL water at 70 degree C. under magnetic stirring at 650 rpm followed by addition of 0.925 g sodium silicate (5.00 mL 37% w/v solution) and then 1.0 g PVP powder (10,000 MW). In a separate glass vial, dissolve 2.0 g of Tannic acid in 5 mL (2M) phosphoric acid. Add the tannic acid solution dropwise to the conical flask under magnetic stirring, and then adjust the pH to 6.0 using 2.0M phosphoric acid or sodium hydroxide. Maintain the temperature at 70 degree C. throughout the synthesis process. The product formulation appeared as dark pink color upon cooling.

### Example 2: A Composition Containing Caffeine—An Example of a Food and Beverage Ingredient

Synthesis protocol: Dissolve 0.075 g of caffeine and 0.02 g of tannic acid in 10 ml of Ethanol (95% v/v). In a separate vial, dissolve 0.01 g of PVP in 15 mL of DI water. Add the caffeine and tannic acid solution dropwise into the PVP solution under magnetic stirring (˜650 rpm).

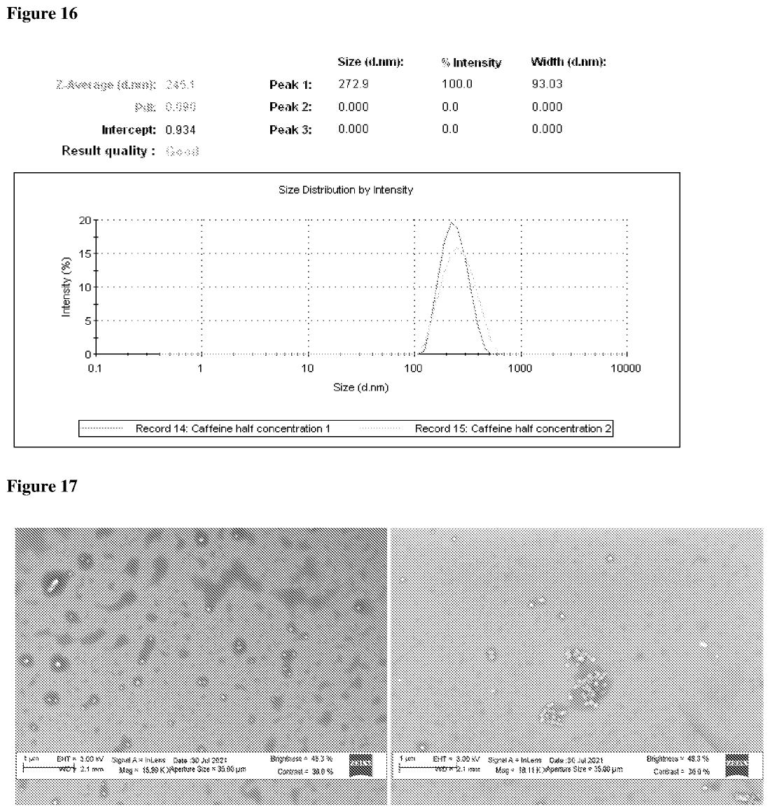

Particle size distributions and SEM images of TA-PVP-Caffeine nanoparticles is found in FIGS. 16 and 17.

### Example 3: A Composition Containing Indole Acetic Acid (IAA)—An Example of an Agrochemical Active Ingredient

Synthesis protocol: Dissolve 0.02 g of IAA and 0.02 g of tannin acid in 5 ml of Ethanol (95% v/v). In a separate vial, dissolve 0.01 g of PVP in 15 mL of DI water. Add the IAA and tannic acid solution dropwise into the PVP solution under magnetic stirring (˜650 rpm).

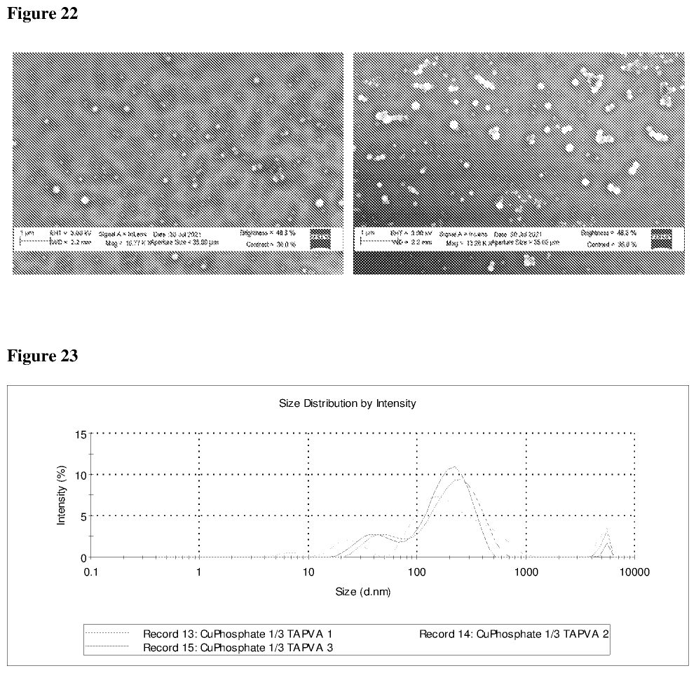

Particle size distributions and SEM images of TA-PVP-IAA nanoparticles is found in FIGS. 21 and 22.

### Example 4: A Composition Containing Curcumin—An Example of a Pharmaceutical Active Ingredient

Synthesis protocol: 55 mg of curcumin is dissolved in 5 mL 95% ethanol in a 15 mL conical tube. 1 mL of the curcumin ethanolic solution is transferred into another 15 mL conical tube, and to it 170 mg of tannic acid is added. The resulting curcumin-tannic acid ethanolic solution is vortexed and sonicated until all the powder has dissolved. 85 mg of PVP (8,000 MW) is then dissolved in 9 mL of deionized water. The curcumin-tannic acid ethanolic solution will then be added dropwise into the aqueous PVP solution under constant magnetic stirring at 800 rpm. After all the curcumin-tannic acid is added, magnetic stirring will continue for an additional 10 minutes at the same rpm.

### Example 5: A Composition Containing Sesamol—An Example of a Plant Material Active Ingredient

Synthesis protocol: Dissolve 0.075 g of sesamol and 0.018 g of tannic acid in 10 ml of Ethanol (95% v/v). In a separate vial, dissolve 0.01 g of PVP in 15 mL of DI water. Add the tannic acid solution dropwise into the PVP solution under magnetic stirring (˜650 rpm).

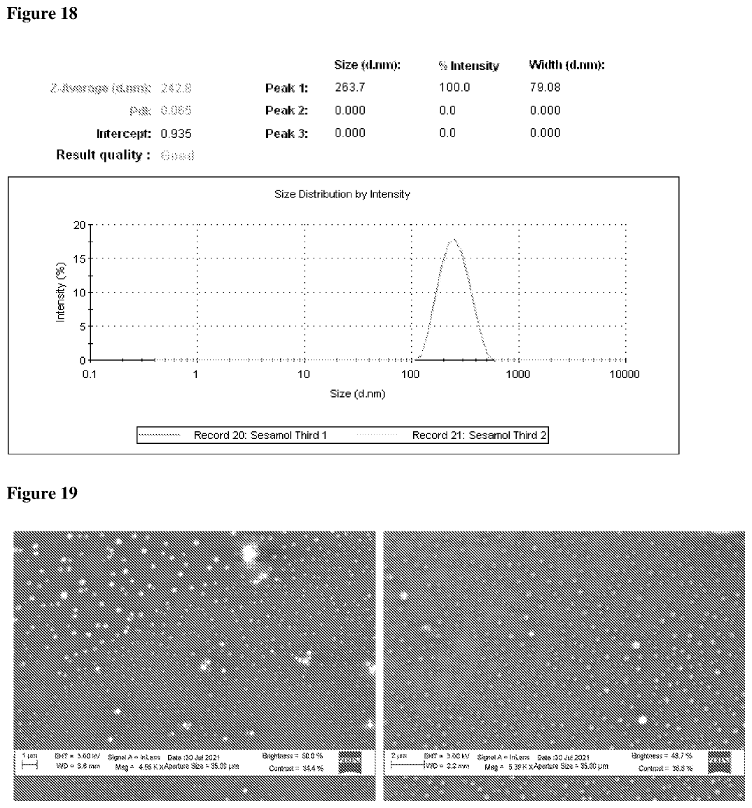

Particle size distributions and SEM images of TA-PVP-Sesamol nanoparticles is found in FIGS. 18 and 19.

### Example 6: A Composition Containing RNA—An Example of a Pharmaceutical Active Ingredient

Synthesis protocol: Dissolve 0.075 g of RNA and 0.018 g of tannic acid in 10 ml of Ethanol (95% v/v). In a separate vial, dissolve 0.01 g of PVP in 15 mL of DI water. Add the tannic acid solution dropwise into the PVP solution under magnetic stirring (˜650 rpm).

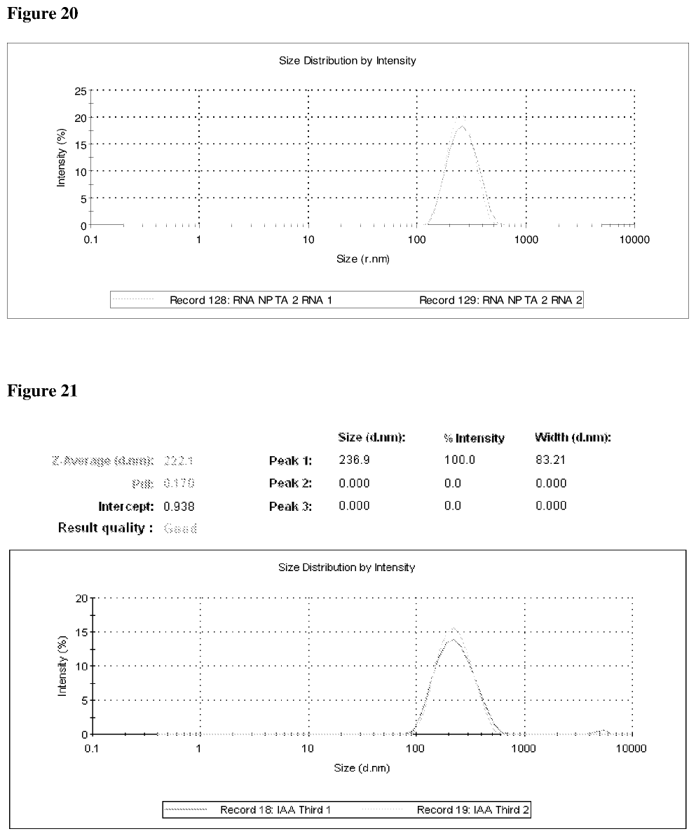

Particle size distributions of TA-PVP-RNA nanoparticles is found in FIG. 20.

### Example 7: A Composition Containing Inorganic Ions

Synthesis protocol: General protocol: Dissolve 5 mg TA and PVA in 10 ml dilute phosphate buffer (pH 9.0). Add an ion solution (Cu²⁺, Zn²⁺ or a mixture thereof) to the TA-PVA solution under constant stirring (˜650 rpm).

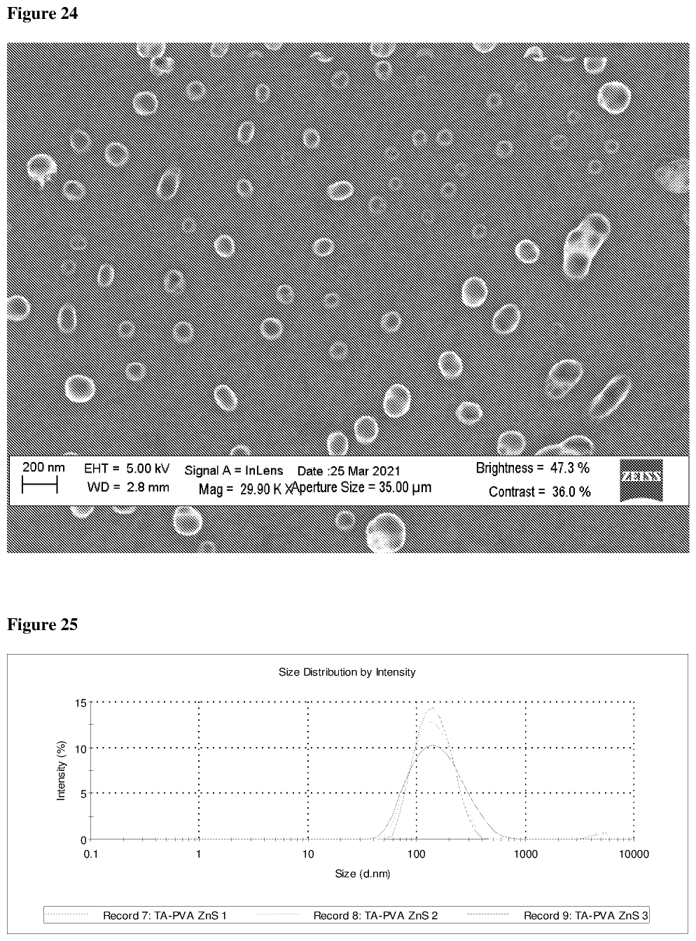

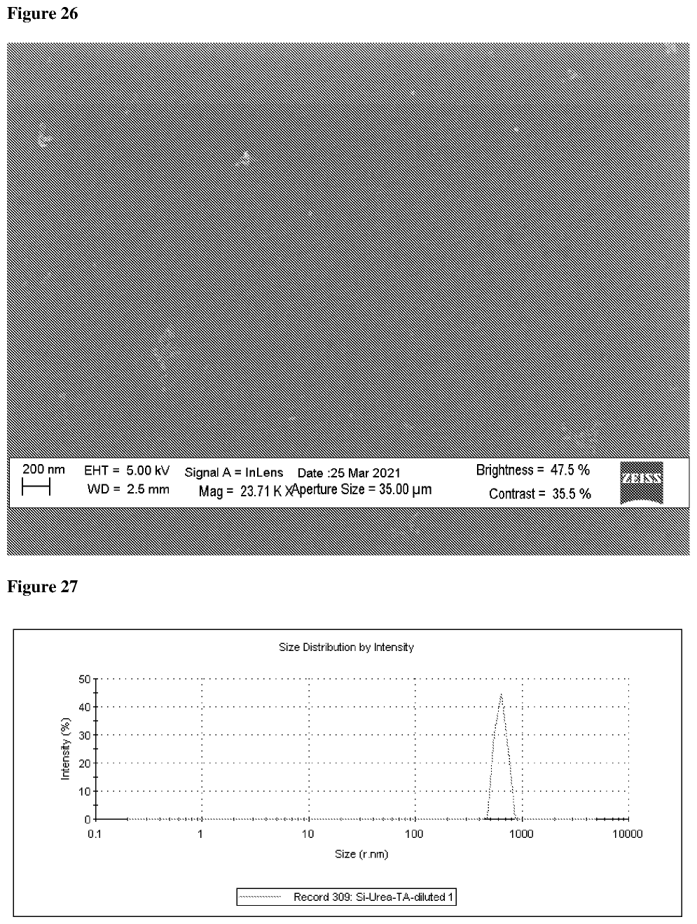

Particle size distributions and SEM images of TA-PVP-Cu²⁺ and TA-PVP-Zn²⁺ nanoparticles is found in FIGS. 23-26.

### Example 8: A Composition Containing SiO₂-Urea

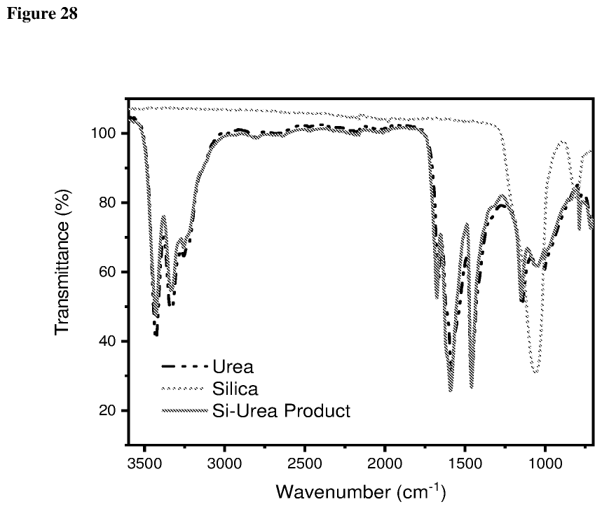

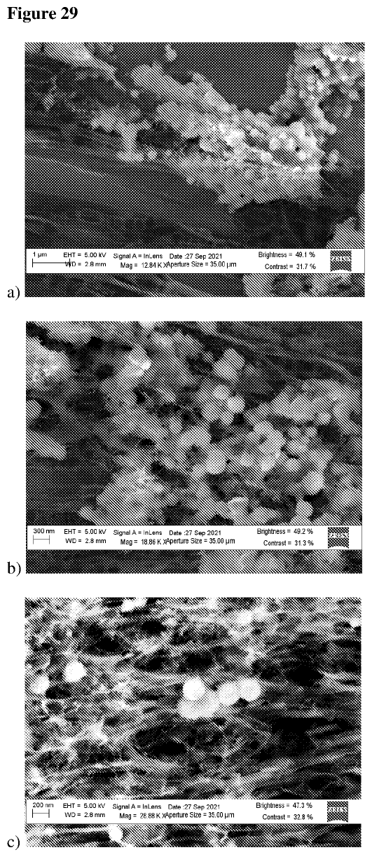

Synthesis Protocol: In a 250 mL conical flask, dissolve 25.0 g urea in 15 mL water at 70 degree C. under magnetic stirring at 650 rpm followed by addition of 0.925 g potassium silicate and then 1.0 g PVP powder (10,000 MW). In a separate glass vial, dissolve 2.0 g of Tannic acid in 5 mL (2M) phosphoric acid. Add the tannic acid solution dropwise to the conical flask under magnetic stirring, and then adjust the pH to 6.0 using 2.0M phosphoric acid or sodium hydroxide. Maintain the temperature at 70 degree C. throughout the synthesis process. Particle size distributions and SEM images of TA-PVP-SiO₂-Urea nanoparticles is found in FIGS. 27-29.

### Example 9: Curcumin-Loaded Nanoparticles for Drug Delivery Optimization in the Treatment of Peripheral Nerve Injury

Peripheral nerve injuries (PNI) affect 20 million people, with over 200,00 nerve repairs performed annually in the United States. studies largely use unoptimized curcumin which presents an issue as it is hydrophobic and degrades quickly in aqueous solutions.

In this example, a nano-formulation comprised of tannic acid and polyvinylpyrrolidone (TA-PVP) was developed to encapsulate curcumin and optimize its delivery to cells. Results show that the developed Cur-TA-PVP nanoparticles (NPs) had an average size of 220 nm, a surface charge of −35 mV, and a polydispersity index of 0.3. Further, curcumin is shown to be localized within the core of the NP. This significantly increases the colloidal stability, decreases the degradation rate, and promotes the slow release of curcumin in aqueous solutions. The 2,2-diphenyl-1-picrylhydrazyl (DPPH) radical scavenging activity of the Cur-TA-PVP NPs is also shown to be superior as compared to free curcumin. Finally, fluorescence microscopy reveal a significantly higher concentration of curcumin in SH-SYSY, S16 rat Schwann cells, and J774 murine macrophages when delivered via NPs. These results collectively provide evidence for the improved physicochemical properties of the nano-curcumin, which leads to improved delivery to cells.

9.1 Materials

Curcuminoids (HPLC>95%) were obtained from Alfa Aesar (USA). Tannic acid (molecular weight 748), polyvinylpyrrolidone (molecular weight 8000), and 95% ethanol were obtained from Sigma Aldrich (USA). Phosphate buffered saline (PBS) was obtained from Thermo Fisher (USA).

9.2 Instrumentation

Malvern Zetasizer Nano ZS90 was used to study the hydrodynamic size, surface charge, and polydispersity index (PDI) of the NPs. Agilent Cary 300 Bio UV-Vis spectrophotometer was used to measure the absorbance of materials across the UV-Visible spectrum. Spectronic 200 spectrophotometer was used to carry out the degradation and release rate studies. Samples were freeze-dried using a Labconco lyophilizer. Shimadzu IRSpirit with QATR-S was used to obtain

the Fourier transform infrared spectroscopy spectra of materials. SPEX Nanolog

Spectrofluorometer was used to determine the fluorescence spectra of materials. Tecan M200 and SpectraMax i3x microplate readers were used to measure the absorbance of curcumin (standard curve generated on each instrument used). Eppendorf 5810R and 5414D centrifuges were used to pull NPs down into pellets.

9.3 Methodology

9.3.1 Synthesis of Optimized Curcumin-Loaded Nanoparticles

11 mg of curcumin powder was dissolved in 1 mL 95% ethanol and sonicated until completely dissolved. 170 mg of TA was then added into the curcumin-ethanolic solution and sonicated until all the powder had dissolved. The curcumin-TA ethanolic solution was then added dropwise into 9 mL of a 9.4 mg/mL aqueous PVP solution under constant magnetic stirring at 1000 rpm. After all the curcumin-TA was added, magnetic stirring continued for an additional hour. The final molar concentrations of curcumin, TA, and PVP were 0.03 mM, 0.1 mM, and 0.001 mM, respectively.

9.3.2 Physicochemical Characterization

9.3.2.1 Dynamic Light Scattering (DLS) and Zeta Potential (ZP)

DLS and ZP measurements were done using a Malvern Zetasizer ZS90 to determine the samples' hydrodynamic size and surface charge, respectively. The samples were diluted to approximately 200 ppm of curcumin to obtain 100 to 1000 kilo counts per second (kcps). Samples were added into the appropriate cuvettes for DLS and ZP readings.

9.3.2.2 Encapsulation Efficiency (EE)

EE was measured to determine the percentage of curcumin captured by the NP system from what was initially introduced during synthesis. A standard curve was first generated by performing a serial dilution of curcumin in 95% ethanol for a concentration range of 0-20 μM (linear range). The absorbance of curcumin at each dilution was then measured at 425 nm using a SpectraMax i3x plate reader, and the values were plotted against the corresponding concentrations. 1 mL of the synthesized Cur-TA-PVP NPs was then centrifuged at 10,000 rpm on a benchtop microcentrifuge for 15 minutes. The supernatant was then dissolved in ethanol according to a dilution factor that allowed for measurement within the linear range of absorbance (0.1-1). The EE was then calculated according to the equation below:

$$EE \% = 100 \% - ( \frac{curcumin in supernatant}{curcumin introduced during synthesis} \times 100 \% )$$

9.3.2.3 Scanning Electron Microscopy (SEM)

The Cur-TA-PVP NPs were imaged to determine their morphology. Samples were washed by centrifuging the NPs at 10,000 rpm for 10 minutes using a 5810R centrifuge, removing the supernatant, and then resuspending the pellet in deionized water. This wash step was done twice. The final solution was then diluted to a final concentration of approximately 200 ppm and drop-casted onto a silicon wafer. The sample was then dried in a desiccator for 24 hours and imaged using a scanning electron microscope under high vacuum conditions.

9.3.2.4 UV-Visible Spectroscopy

The absorbance spectrum of the Cur-TA-PVP NPs was determined to identify and confirm the presence of curcumin, TA, and PVP within the system based on their characteristic peaks. The Cur-TA-PVP and TA-PVP NP suspensions were washed twice as previously explained, and the

The resulting solutions were then diluted to ensure absorbance measurements were acquired within the linear range. TA, PVP, and curcumin controls were also included. Before reading the samples, background corrections using deionized water were done on the Cary 300 Bio UV-Vis spectrophotometer. Absorbance scans of the samples were obtained in the range of 200 nm to 600 nm.

9.3.2.5 Fourier Transform Infrared Spectroscopy (FTIR)

The chemical composition and interactions in samples were determined by acquiring their FTIR spectra. Washed Cur-TA-PVP NP and TA-PVP NP samples were frozen at −20° C. overnight and then freeze-dried using a Labconco lyophilizer. The resulting powders were pulverized to reduce them into finer particles. Background corrections were done before loading samples onto the probe by obtaining measurements of air.

9.3.2.6 Fluorescence Spectroscopy

The fluorescence emission of Cur-TA-PVP NP and free curcumin were obtained to deduce information on the spatial distribution of curcumin in the NP system. Cur-TA-PVP NPs were washed as previously explained, and then diluted in water within a quartz cuvette. Additionally, 95% curcuminoid powder was dissolved in 95% ethanol, and the resulting solution was diluted in water within a quartz cuvette as well. Samples were placed in a SPEX Nanolog spectrofluorometer to acquire their fluorescence spectra; the excitation wavelength was set to 425 nm, and the emission wavelength was set from 450 nm to 700 nm.

9.3.2.7 Degradation Rate

The degradation rate of Cur-TA-PVP NPs and free curcumin was determined by measuring the peak absorbance over time as this can be correlated to the concentration in solution. Both samples were diluted (from fresh stocks) in water to a final concentration of 40 μM and transferred into individual cuvettes. Absorbance readings of samples were acquired at 425 nm every 60 minutes for 24 hours. Degradation rate equations were determined based on the trendlines that provide an R2 of 0.95 or greater. Simple linear regressions were also performed to compare the slopes of the degradation curves to determine if the difference was statistically significant.

9.3.2.8 Release Rate

The release of curcumin from NPs was evaluated over a period of 30 hours. An aliquot of freshly synthesized Cur-TA-PVP NPs was diluted in deionized water to a final concentration of 10 μM and a volume of 50 mL. At each time point, 5 mL of the solution was centrifuged at 12,000 rpm for 30 minutes. 1 mL of the solution was transferred into a cuvette and the absorbance was read at 425 nm. The concentration of curcumin was calculated using the standard curve, as explained previously. The percent drug release at each time point was calculated using the equation below. The equation accounts for the initially released curcumin that inevitably degrades by the time of measurement (degradation equation obtained from section 2.3.2.7). Additionally, the data points were normalized to reflect ‘zero release’ at time point zero to cancel out the small proportion of relatively small NPs which cannot be pulled down during centrifugation, as well as the initially unencapsulated curcumin.

$$\% release ( {t}_{min} ) = ( \frac{curcumin in supernatant}{initial curcumin in dispersion} ) \times 100 \% + \% initially released curcumin degraded by {t}_{min}$$

9.3.2.9 2,2-diphenyl-1-picryhyldrazyl (DPPH) Radical Scavenging Activity

The antioxidant potential of samples was determined by measuring the degree of DPPH scavenging activity. Treatments were prepared in microcentrifuge tubes by mixing 280 μL of DPPH (80 ug/mL), 10 μL of absolute ethanol, and 10 μL of the treatment (Cur-TA-PVP NPs, free curcumin, or ascorbic acid) to provide a final active ingredient concentration of 5 μM; ascorbic acid was used as a positive control as it is a well-established potent antioxidant. ‘Blanks’ for all treatments were also included, in which no DPPH was added. The negative control was DPPH alone, in which 280 μL was mixed with 20 μL of absolute ethanol. 100 μL of the prepared samples were transferred into a 96 well plate in replicates of 5, and the absorbance was read at 517 nm after 1 hour. The DPPH radical scavenging activity was calculated using the equation below. A one-way ANOVA was then performed using GraphPad Prism 9 to determine statistically significant differences between groups.

$$\% D P P H scavenging activity = \frac{\begin{matrix}( D P P H abs - ( treatment abs - \\ treatment blank abs ) )\end{matrix}}{D P P H abs} \times 100 \%$$

9.4 Results

9.4.1 Appearance of Formulations

The results in section 9.4 collectively show that Cur-TA-PVP NPs were successfully synthesized and demonstrate the physicochemical characteristics as predicted. It can be observed that when curcumin is encapsulated by the TA-PVP carrier, its colloidal stability in water dramatically improves; this is evident by the homogenous appearance of the yellowish-orange color throughout the aqueous solution that is characteristic of curcumin. In contrast, when free curcumin is introduced into water in its free form, it does not exhibit the same level of stability. As expected, its hydrophobicity limits its interactions with water molecules, thus causing it to precipitate and sink to the bottom of the vial. This result is important as the hydrophobic nature of curcumin causes most of the molecules to remain in the lipid bilayer when administered to cells in the free form, as shown by Kunwar et al. [Kunwar, A., et al., Quantitative cellular uptake, localization and cytotoxicity of curcumin in normal and tumor cells. Biochim Biophys Acta, 2008. 1780(4): p. 673-9.]. Curcumin directly interacts with or leads to the upregulation of many intracellular proteins involved in anti-inflammation, antioxidant, neuroprotective, and re-myelination pathways [Caillaud, M., et al., Key Developments in the Potential of Curcumin for the Treatment of Peripheral Neuropathies. Antioxidants (Basel), 2020. 9(10).]. Thus, the therapeutic potential of free curcumin is lowered by its propensity to reside in the lipid bilayer. Since the TA-PVP carrier improves the stability of curcumin in water, it is therefore expected that this would enhance its availability within the cytoplasm of cells to reach or upregulate targets involved in achieving successful PNR. The NP formulation dramatically increases the colloidal stability of curcumin compared to its free form alone in the aqueous solution.

9.4.2 Hydrodynamic Size, Surface Charge, Polydispersity Index, and Encapsulation Efficiency of Optimized Formulation

A summary of some physical characteristics of the optimized formulations of Cur-TA-PVP NPs and TA-PVP NPs is shown in table 1. The hydrodynamic size and ZP of the Cur-TA-PVP

NPs are 220 nm (diameter) and −35 mV, respectively. This ZP value, in part, explains the increased stability of the particles in water compared to free curcumin; particles that have a surface charge greater than 1301 mV demonstrate increased colloidal stability due to particles repelling one another in solution [Clogston, J. D. and A. K. Patri, Zeta potential measurement. Methods Mol Biol, 2011. 697: p. 63-70.]. Additionally, the polydispersity index (PDI) measures the homogeneity of particle size in solution. A value of 0.1 implies a monodisperse size distribution, whereas values over 0.1 to 1 imply an increasingly polydisperse size distribution [Clayton, K. N., et al., Physical characterization of nanoparticle size and surface modification using particle scattering diffusometry. Biomicrofluidics, 2016. 10(5): p. 054107.]. The Cur-TA-PVP NPs are shown to have a PDI of 0.3 which is fairly monodisperse. Together, these values provide a quantitative measure for the observed increased stability of curcumin in the aqueous solution. Additionally, the encapsulation efficiency (EE) of this formulation is 88%, which indicates that most of the curcumin molecules introduced during synthesis have been successfully encapsulated by the TA-PVP carrier. More on the studies conducted in this research to optimize the EE will be discussed in the next section.

It should be noted that the TA-PVP control included in table 1 contains the same concentrations of TA and PVP as in the Cur-TA-PVP NPs but without curcumin. Like the Cur-TA-PVP NPs, the TA-PVP carrier has a surface charge of −35 mV. This suggests that the TA-PVP exists as a ‘shell’ surrounding a curcumin ‘core’.

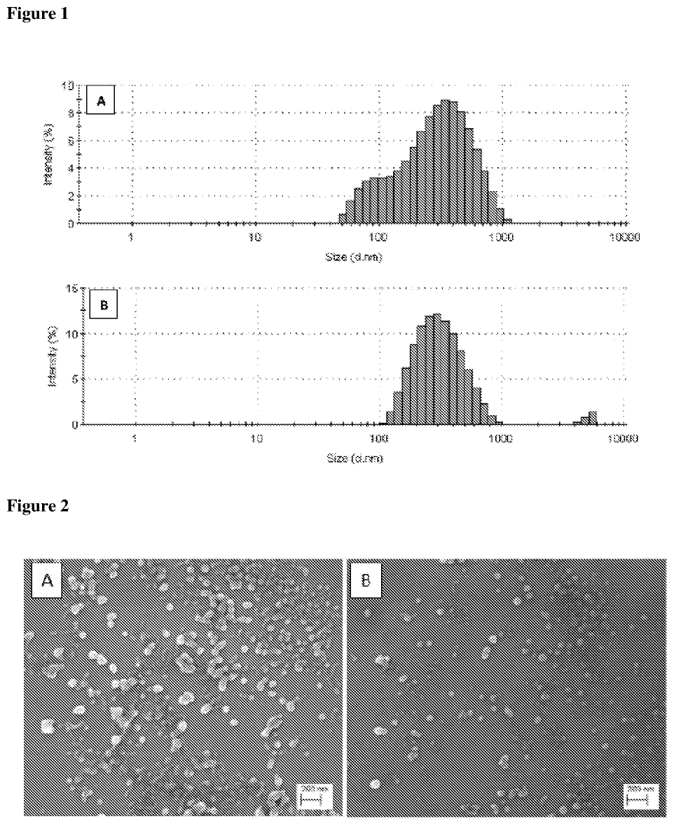

The hydrodynamic size distribution of the NPs measured by DLS is shown in FIG. 1. Histograms (A) and (B) show the size distributions of Cur-TA-PVP and TA-PVP NPs respectively.

TABLE 1
hydrodynamic size, surface charge, PDI, and EE of optimized
Cur-TA-PVP (TA-PVP and free curcumin controls shown)

| | | | Polydispersity | Encapsulation |
|---|---|---|---|---|
| | Z-ave | Zeta Potential | Index | Efficiency |
| Formulation | (d · nm) | (mV) | (PDI) | (%) |
| Cur-TA-PVP | 220 | −35 | 0.301 | 88 |
| TA-PVP | 302 | −35 | 0.248 | NA |
| Free Curcumin | 328 | −13 | 0.578 | NA |

9.4.3 Optimization of the Encapsulation Efficiency (EE)

As was briefly alluded to in the previous section, the EE is the percentage of curcumin introduced during synthesis that is ultimately captured by the TA-PVP NPs. This aspect is important to ensure a high yield of curcumin NPs. As shown in table 2, the EE obtained with the very first formulation (Cur:TA:PVP=1:1:0.01) was 36%. This value can be regarded as low as most of the curcumin within the solution still exists in its free form. To improve this, increasing ratios of TA and PVP to curcumin were used so that more would be available to interact with curcumin and form the ‘shell’ of the NP. From this effort, the EE increased to 68%, at which point the values plateaued, as shown in table 2. This meant that the limiting factor in the EE was no longer the amount of TA and PVP present in solution to capture curcumin. Rather, the volume of the aqueous solution itself became the limiting factor; since curcumin does exhibit a low level of water solubility (0.1 mg/mL), the amount that can be captured is limited as the formation of NPs is in part dependent upon the precipitation of curcumin from solution. Therefore, decreasing the volume of the synthesis product would lead to increased precipitation of curcumin, leading to a higher rate of formation of Cur-TA-PVP NPs. This result can be seen in table 3, where synthesis volumes were decreased from 15 mL to 10 mL for some formulations that initially exhibited an EE plateau. It was found that this decrease in volume led to a significant increase in EE for any given molar ratio of Cur:TA:PVP. Ultimately, the EE was increased to 88% by fixing the ratios of Cur:TA:PCP at 1:3.3:0.035 and decreasing the total volume to 10 mL.

TABLE 2
Optimization of the EE by increasing the molar ratios of TA and PVP to curcumin.
A plateau is noted beginning at molar ratios 1:2.3:0.025 (Cur:TA:PVP).

| Molar ratio | Volume | Volume | | | | |
|---|---|---|---|---|---|---|
| of | of | of 95% | | Zeta | | |
| formulation | Water | Ethanol | Z-ave | Potential | Polydispersity | Encapsulation |
| (Cur:TA:PVP) | (mL) | (mL) | (d · nm) | (mV) | Index (PDI) | Efficiency (%) |
| 1:1:0.01 | 14 | 1 | 150 | −23 | 0.506 | 36 |
| 1:1.3:0.014 | 14 | 1 | 148 | −35 | 0.39 | 35 |
| 1:1.7:0.018 | 14 | 1 | 169 | −38 | 0.387 | 52 |
| 1:2:0.021 | 14 | 1 | 207 | −33 | 0.501 | 66 |
| 1:2.3:0.025 | 14 | 1 | 230 | −40 | 0.549 | 68 |
| 1:2.7:0.028 | 14 | 1 | 208 | −38 | 0.506 | 68 |
| 1:3:0.032 | 14 | 1 | 229 | −26 | 0.628 | 66 |

TABLE 3
Further optimization of the EE by increasing molar ratios
TA and PVP to curcumin, and reducing the overall volumes

| Molar ratio | Volume | Volume | | | | |
|---|---|---|---|---|---|---|
| of | of | of 95% | | Zeta | | |
| formulation | Water | Ethanol | Z-ave | Potential | Polydispersity | Encapsulation |
| (Cur:TA:PVP) | (mL) | (mL) | (d · nm) | (mV) | Index (PDI) | Efficiency (%) |
| 1:2:0.021 | 14 | 1 | 207 | −33 | 0.501 | 66 |
| 1:2:0.021 | 9 | 1 | 210 | −46 | 0.408 | 77 |
| 1:3:0.032 | 14 | 1 | 229 | −26 | 0.628 | 66 |
| 1:3:0.0.32 | 9 | 1 | 214 | −40 | 0.455 | 82 |
| 1:3.3:0.035 | 9 | 1 | 220 | −35 | 0.301 | 88 |

9.4.4 Scanning Electron Microscopy (SEM)

FIG. 2 shows the SEM images of the optimized Cur-TA-PVP NPs and TA-PVP NPs. It can be observed that the NPs have a spherical morphology and minimal agglomeration. Further, the bimodal size distribution of the Cur-TA-PVP NPs demonstrated by the DLS data is also evident in the SEM images, with the presence of particles under and beyond 100 nm.

Both samples are comprised of spherical NPs. The images also demonstrate the bimodal size distribution suggested by the DLS data, as shown in FIG. 1.

9.4.5 UV-Visible Spectroscopy

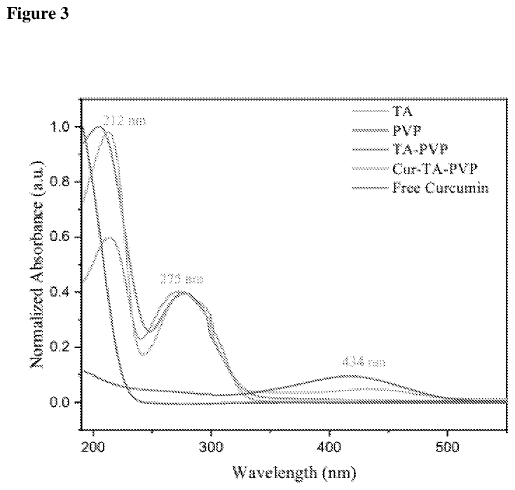

FIG. 3 demonstrates the UV-Visible spectra of Cur-TA-PVP and TA-PVP NPs, as well as their controls. The Cur-TA-PVP spectrum exhibits maximum absorption peaks corresponding to each component introduced during the synthesis. First, the peak at 434 nm is characteristic of curcumin, indicating its successful capture into the NP system. The peak at 275 nm corresponds to TA, and the peak at 212 nm corresponds to both TA and PVP. The 212 nm peak's absorbance value is greater than that in the TA control, and this is due to the presence of PVP in the NP which also absorbs in that region of wavelengths. These results therefore confirm that the NP is composed of TA, PVP, and curcumin.

9.4.6 Fourier Transform Infrared (FTIR) Spectroscopy

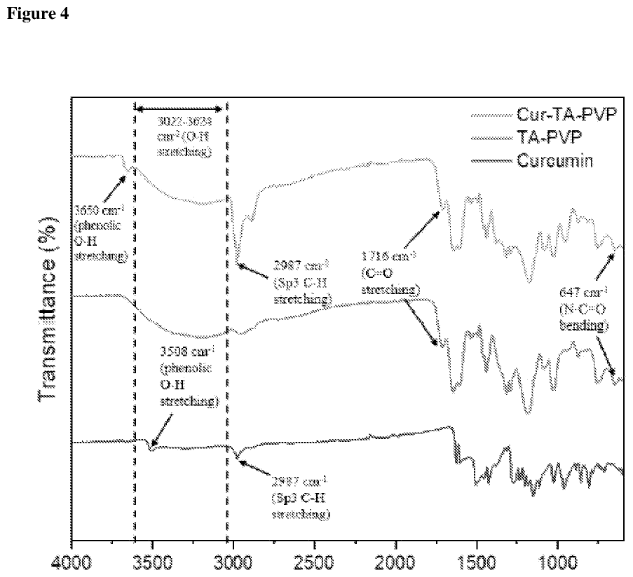

FTIR presents another method to confirm the presence of the components in the NP system and any interactions thereof. FIG. 4 shows the FTIR spectra of the Cur-TA-PVP NPs, TA-PVP NPs, and free curcumin. First, the broad O—H stretching from 3022 to 3624 cm-1 characteristic of TA can be seen in both the Cur-TA-PVP and TA-PVP spectra. Additionally, the N—C═O bending characteristic of PVP also occur in both NP spectra at 647 cm-1. The phenolic O—H stretching peak characteristic of curcumin shifts from 3508 cm-1 to 3650 cm-1 in the presence of TA-PVP; this implies the capture of curcumin in its stable form by the NP system. Sp3 C—H stretching can also be seen in all spectra at about 2987 cm-1, with pronounced bands in the Cur-TA-PVP spectrum; this may be due to a compounding effect of this chemical bond which is present in all molecules of the NP system. Overall, the results provide evidence of the formation of the TA-PVP carrier and the successful capture of stable curcumin into the NP system.

9.4.7 Fluorescence Spectroscopy

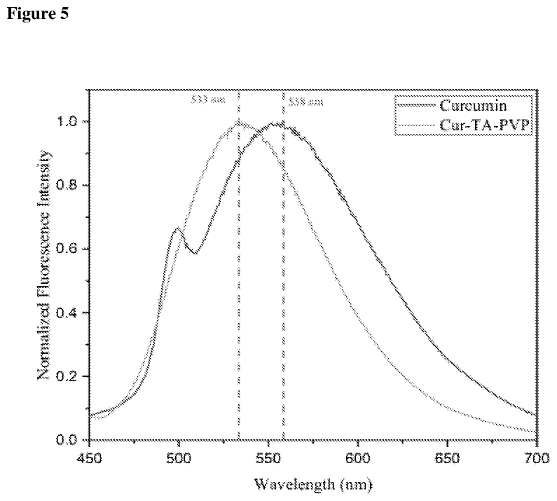

Given that curcumin has inherent fluorescence, this property can be leveraged to determine the localization of curcumin in the NP system, according to the principle of solvatochromism. FIG. 5 shows the emission spectra of Cur-TA-PVP NPs and free curcumin in water when excited at 425 nm. There is a notable blue shift in the peak emission, from 558 nm to 533 nm, when curcumin is encapsulated by TA-PVP. The two peaks imply that curcumin exists in two different environments. Specifically, the peak at 558 nm for the free form indicates that curcumin exists in an aqueous environment, whereas the peak at 533 nm indicates that curcumin exists in

the hydrophobic core of the NP. This result is of value as an important goal of the NP is to shield curcumin from the aqueous environment and protect it from degradation.

9.4.8 Degradation Rate

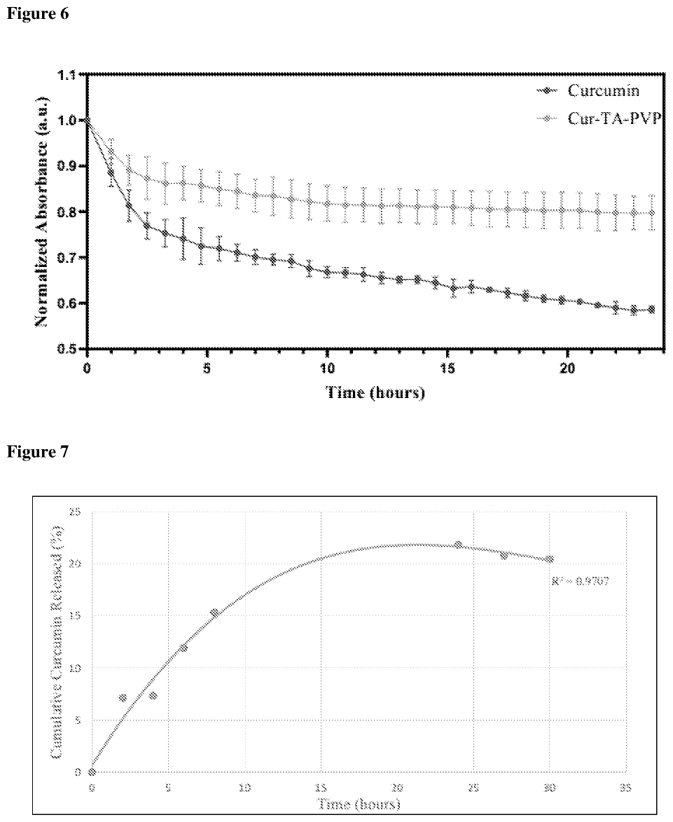

Given the evidence showing the successful capture of curcumin by TA-PVP and its localization within the core of the NP, it was expected that curcumin would be relatively protected from premature degradation in aqueous solutions. Indeed, this result was observed as shown in FIG. 6. After 24 hours of dispersion in PBS, over 80% of curcumin remains in its viable form when encapsulated in the NP, whereas only about 60% of curcumin remains when it exists in its free form. Linear regression analysis also demonstrated that the two slopes had a statistically significant difference (−0.01123 and −0.005019 for curcumin and Cur-TA-PVP NPs, respectively), emphasizing the degree of protection offered to curcumin by the NP.

9.4.9 Release Rate of Curcumin from the Nanoparticle

The release rate of curcumin from the NP system was measured until a notable plateau in the cumulative release was observed. FIG. 7 demonstrates that upon the dispersion of Cur-TA-PVP NPs in deionized water, a gradual release of curcumin is achieved for up to about 20 hours, at which point a maximum cumulative release of just over 20% is reached; this value reflects the amount of curcumin that can passively diffuse out due to the concentration gradient within and outside the particle. Since the TA-PVP carrier is biodegradable, it is expected that its degradation would lead to more curcumin release at a later point. A previous study utilizing chitosan to encapsulate curcumin demonstrated such a biphasic release profile, with a total curcumin release by 10 days [Jahromi, H. K., et al., Enhanced sciatic nerve regeneration by poly-L-lactic acid/multi-wall carbon nanotube neural guidance conduit containing Schwann cells and curcumin encapsulated chitosan nanoparticles in rat. Mater Sci Eng C Mater Biol Appl, 2020. 109: p. 110564.]. Thus, the kinetics of this secondary release would need to be assessed in a longer-term study to confirm this assumption.

9.4.10 DPPH Radical Scavenging Activity

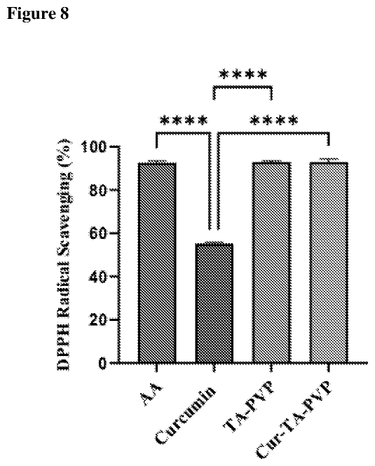

DPPH is a free radical that is used to determine the antioxidant potential of treatments by their ability to scavenge it. FIG. 8 shows the percent DPPH scavenging activity calculated with respect to DPPH without any treatments. Ascorbic acid was used as a positive control as it is a widely established potent antioxidant. Results show that both TA-PVP and Cur-TA-PVP NPs have radical scavenging potential greater than free curcumin, and that equivalent to ascorbic acid. It can therefore be deduced that the Cur-TA-PVP NPs would perform better as an antioxidant compared to curcumin alone. This result is likely due to the presence of TA on the surface of the NP, which has been also shown to be a potent antioxidant due to the numerous hydroxyl groups the molecule has. This assumption is further validated by the fact that the Cur-TA-PVP and TA-PVP treatments

### Example 10: Cell Studies to Determine the Efficacy of the Nanoparticle Delivery System in Increasing the Availability of Curcumin

10.1 Materials

SH-SY5Y (CRL-2266), S16 Schwann cells (CRL-2941), and J774 murine macrophages (TIB-67) were purchased from ATCC. Dulbecco's Modified Eagle Medium (DMEM), DMEM/Nutrient Mixture-F12, penicillin-streptomycin (10,000 U/mL), fetal bovine serum (FBS), 0.5% EDTA-trypsin, phosphate-buffered saline (PBS), and resazurin were purchased from Fisher Scientific. Curcuminoids (HPLC>95%) were purchased from Alfa Aesar (USA). Tannic acid (molecular weight 748) and polyvinylpyrrolidone (molecular weight 8000) were purchased from Acros Organics. L-ascorbic acid and 99.5% glycerol were purchased from Fisher Chemical. 4% paraformaldehyde and Hoechst were purchased from Thermofisher Scientific.

10.2 Instrumentation

An Eppendorf 5840R centrifuge was used to collect cell pellets in conical tubes. A Precision Microprocessor Controlled 280 Series water bath was used to warm up complete medium, trypsin, and PBS. A Puracell TC Direct Heat CO₂ incubator was used to incubate cells at 37° C. and 5% CO₂. A Labculture Radiant Class II Type A2 Biological Safety Cabinet was used to create a sterile environment to facilitate aseptic technique. A Tecan M200 plate reader was used to measure the fluorescence of wells. A Keyence BZ-X800 fluorescence microscope was used to acquire images of cells.

10.3 Methodology

10.3.1 Cell Viability

The viability of cells when treated with Cur-TA-PVP, TA-PVP, or free curcumin was assessed to determine the therapeutic window of treatments. This was done by performing an alamarBlue (resazurin) assay according to the manufacturer's instructions. The cell types assessed were models for those involved in PNI and subsequent PNR: S16 rat Schwann cells (RSCs), J744 murine macrophages, and SH-SY5Y cells (neuronal cell line). SH-SY5Y cells were cultured in DMEM/F12 supplemented with 10% FBS and 1% penicillin/streptomycin, whereas the J744 macrophages and S16 RSCs were cultured in DMEM supplemented with 10% FBS and 1% streptomycin/penicillin.

First, cells (n=3) were seeded in 96 well plates at a density of 104 cells per well and incubated overnight in a humidified atmosphere at 37° C. and 5% CO₂. Cur-TA-PVP and free curcumin were then introduced into the wells at a concentration range of 0 to 80 μM curcumin. In the case of TA-PVP, the concentration range was equivalent to TA and PVP concentrations in the Cur-TA-PVP NPs. The plates were incubated for 24 hours, and the media containing treatments was then removed and fresh media with 10% 0.15 mg/mL resazurin was added into all wells. The plates were incubated for 2 hours, and the fluorescence was read using a Tecan plate reader at an ex/em of 560/590 nm. The cell viability was calculated using the following equation.

$$\% cell viability = \frac{fluorescence of treatment wells}{fluorescence of untreated wells ( cells only )} \times 100 \%$$

10.3.2 Fluorescence Microscopy

The relative concentration of curcumin in cells when delivered in the encapsulated or free form was evaluated by performing fluorescence microscopy. First, glass coverslips were plasma treated to sterilize them and increase their hydrophilicity immediately before initiating the experiment. The coverslips were then each placed into a well of a 6 well plate. SH-SY5Y (1×106 cells/well), J774 macrophages (5×105), and S16 RSCs (5×105) were seeded onto the coverslips in individual plates. The cells were left to adhere overnight in an incubator at 37° C. and 5% CO₂. The media was replaced with media containing Cur-TA-PVP or free curcumin (10 μM curcumin for macrophages, and 5 μM curcumin for RSCs and SH-SY5Y cells) and incubated again for 24 hours. Cells were then washed with PBS and fixed with 4% paraformaldehyde for 10 minutes at room temperature. Cells were then washed three times with PBS, and 10 μg/mL of Hoechst solution (diluted in PBS) was introduced into wells and allowed to incubate at room temperature for 10 minutes. Cells were washed once more with PBS before being mounted onto glass slides. The mounting medium used was a solution of 90% glycerol supplemented with 2 mg/mL L-ascorbic acid. Clear nail polish was used to seal the edges of the coverslip on the glass slide, and allowed to harden for two hours before image acquisition on a Keyence BZ-X800 fluorescence microscope. Curcumin and Hoechst were viewed in the green and blue channels, respectively.

The green fluorescence intensity in the acquired images was then quantified using Fiji. For each experimental condition (n=3), the number of cells and global intensity were quantified, and from that, the mean fluorescence intensity per cell was calculated. The fluorescence intensity was normalized against the Cur-TA-PVP images since they had the highest intensity. A one-way ANOVA was then performed using GraphPad Prism 9 to determine statistically significant differences between groups.

10.3.3 H₂O₂-Induced Oxidative Stress and Cell Viability

The potential for Cur-TA-PVP, TA-PVP, or free curcumin to rescue cells from oxidative damage induced by H₂O₂ was assessed to determine the antioxidant activity of the treatments in cells. The assay was performed according to a previously published protocol by Mahakunakorn et al. [Mahakunakorn, P., et al., Cytoprotective and cytotoxic effects of curcumin: dual action on H₂O₂-induced oxidative cell damage in NG108-15 cells. Biol Pharm Bull, 2003. 26(5): p. 725-8.]. Briefly, SH-SY5Y cells and J744 murine macrophages were each seeded in 96 well plates (n=3) and incubated overnight at 37° C. and 5% CO₂. Cells were then pre-treated with fresh media containing treatments for 6 hours, and then with fresh media containing 100 μM H₂O₂ (J774) or 50 μM (SH-SY5Y) for another 18 hours. The media was then replaced with complete media containing 10% of 0.15 mg/mL resazurin. The cells were incubated for 2 hours, and the fluorescence was read at an ex/em of 560/590 nm. The cell viability was determined using the equation noted in section 10.3.1.

10.4 Results

10.4.1 Cell Viability Assays to Determine the Therapeutic Window of Treatments

The cell viability was determined by conducting an alamarBlue assay, which utilizes a viability dye known as resazurin. In the presence of metabolically active cells, resazurin gets reduced into resorufin which can be detected via fluorescence at 590 nm. Such an assessment is important to determine the safety profile of treatments on the cell types involved in PNI and subsequent PNR, which in this study are S16 Rat Schwann cells (RSCs), J774 murine macrophages, and SH-SY5Y cells. As previously explained, SCs play a pivotal role in guiding the growth of regenerating axons through physical (bands of Büngner) and chemical (growth factors) cues. They also play a role in eliciting the innate-inflammatory response (Wallerian degeneration) which is necessary for successful PNR. Macrophages on the other hand, are the primary immune cells recruited to the site of injury to facilitate the initial innate-inflammatory response and subsequent anti-inflammatory response. Finally, neurons themselves are important to regenerate axons and bridge the gap inflicted by nerve injury to allow for functional recovery. In this study, SY5Y cells were used as a substitute for primary neurons as they are a cell line often used to model axon regeneration [Al-Ali, H., et al., In vitro models of axon regeneration. Exp Neurol, 2017. 287 (Pt 3): p. 423-434.].

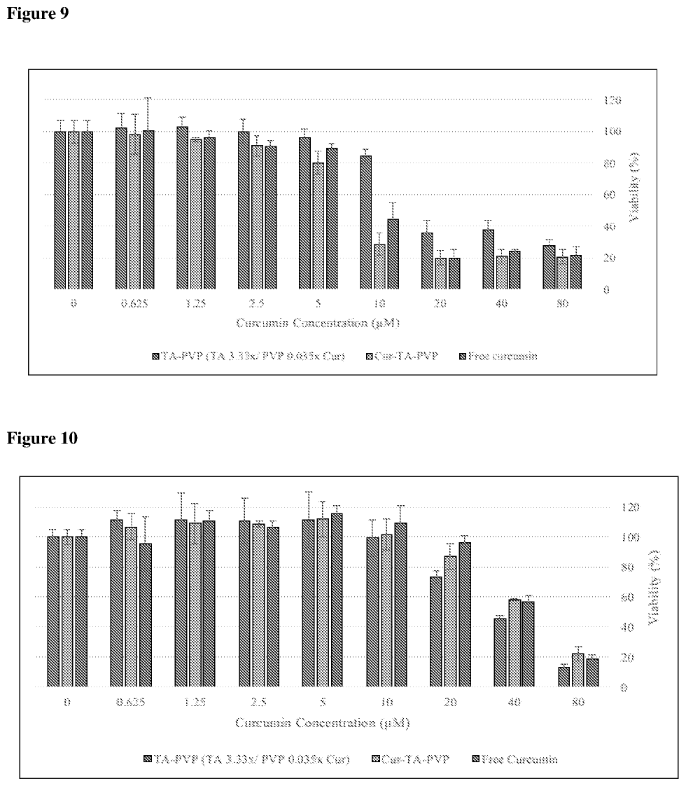

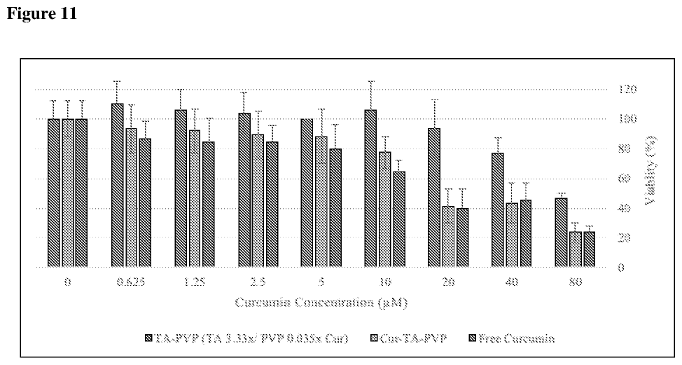

FIG. 9 demonstrates the percent viability of SH-SY5Y cells when treated with Cur-TA-PVP, TA-PVP, or free curcumin for 24 hours. Results show that the viability is uncompromised for TA-PVP and Cur-TA-PVP up to concentrations corresponding to 5 μM of curcumin, beyond which a significant decline is observed. Further, the viability is significantly reduced at 10 μM of curcumin when it is encapsulated in TA-PVP, compared to the free form. This result can be attributed to the fact that both TA and curcumin have been reported to have anti-cancer properties, and SH-SY5Y is a neuroblastoma cell line. FIG. 10 shows the percent viability plot of J774 murine macrophages when treated under the same conditions. Results demonstrate that cell viability is uncompromised up to treatment concentrations corresponding to 10 μM of curcumin. Further, all treatments demonstrate the same trend of cell viability across the tested concentrations. Finally, FIG. 11 demonstrates the viability plot of S16 RSCs when tested with the same treatments. Results demonstrate that the Cur-TA-PVP and TA-PVP treatments begin to affect the cell viability at concentrations corresponding to 5 μM of curcumin. Free curcumin demonstrates higher cell viability than the other treatment groups at all concentrations, especially beginning at 20 μM of curcumin. It can therefore be speculated that S16 RSCs are especially sensitive to the higher level of bioactivity exhibited by TA-PVP and Cur-TA-PVP.

10.4.2 Fluorescence Microscopy to Assess Curcumin Content in Treated Cells

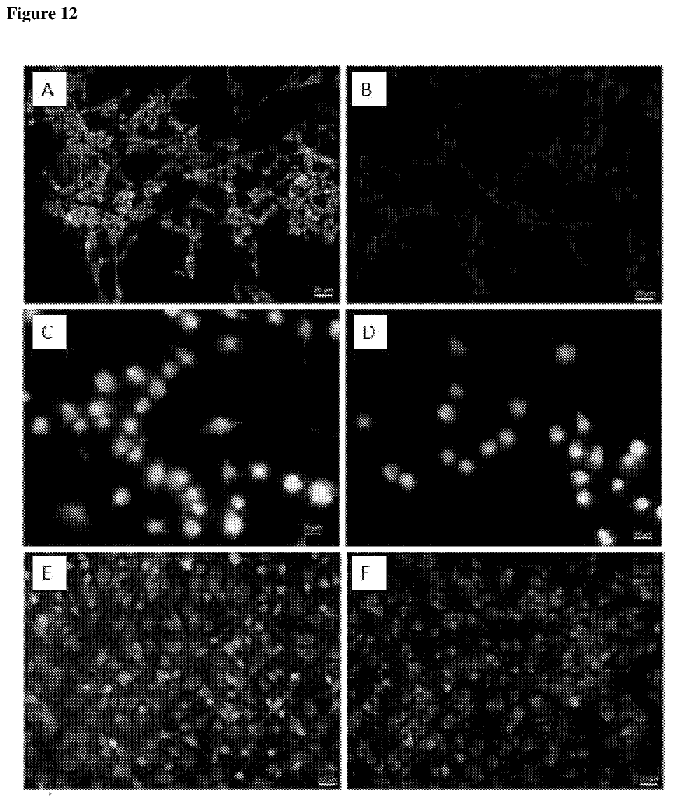

The relative concentration of curcumin in cells when administered in the encapsulated versus free forms was assessed by observing the inherent fluorescence that curcumin exhibits, observable in the green channel. FIG. 12 demonstrates that after 24 hours, SH-SY5Y, J774 murine macrophages, and S16 RSCs exhibit a significantly higher green fluorescence intensity when treated with Cur-TA-PVP as compared to free curcumin. This positive result can be attributed to the enhanced physicochemical properties of curcumin when encapsulated by TA-PVP, as shown by the increased stability in water and reduced degradation rate in chapter two. This ultimately provides evidence for the enhanced delivery of curcumin into cells and its extended lifetime when encapsulated in the TA-PVP NPs. This would ensure that curcumin would be able to interact with intracellular targets to upregulate mechanisms involved in nerve regeneration and re-myelination. Further, the slow and sustained release of curcumin within cells would ensure the continued administration of the therapeutic to reach these targets, reduce oxidative stress and provide a favorable environment for enhanced healing.

10.4.3 H₂O₂-Induced Oxidative Stress and Viability Assay to Determine Antioxidant Potential of Nanoparticles in Cells

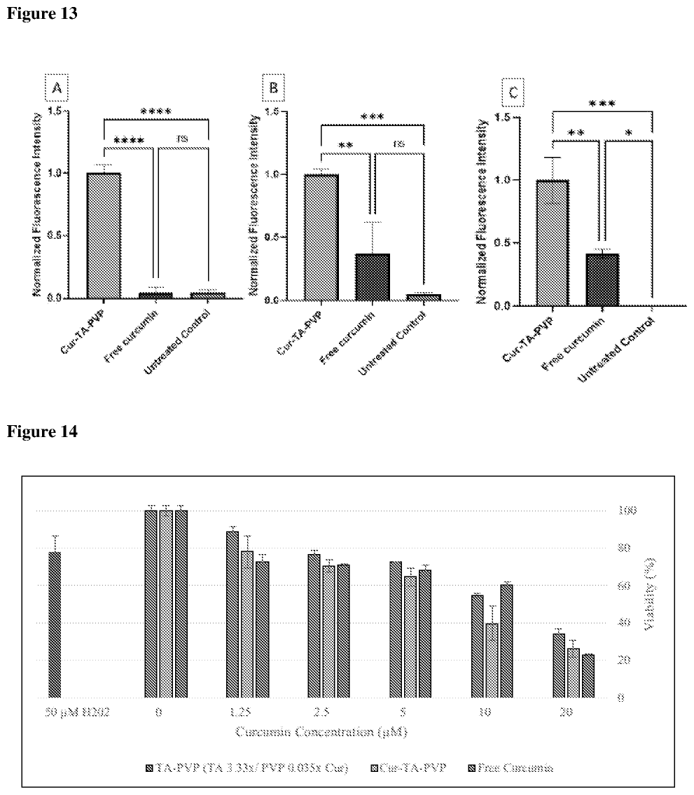

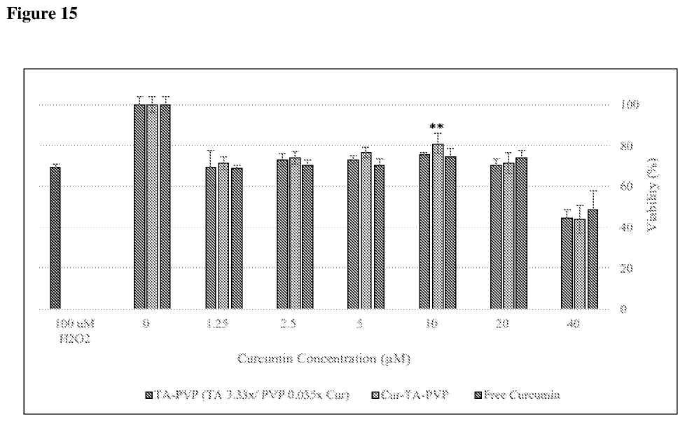

Given the evidence of increased DPPH radical scavenging activity by Cur-TA-PVP compared to free curcumin (FIG. 8) and increased concentration of curcumin in cells when administered in TA-PVP (FIGS. 12 and 13), it was anticipated that the NPs would lead to higher protection against H₂O₂-induced oxidative stress in cells. FIG. 14 shows the result of pre-treating SH-SY5Y cells with Cur-TA-PVP, TA-PVP, or free curcumin for 6 hours, followed by fresh media containing 50 μM H₂O₂ for 18 hours. Results show that there is no cell rescue and that there is instead a concentration-dependent decrease in cell viability. This may be because SH-SY5Y is a neuroblastoma cell line, and both TA and curcumin have been reported to have anti-cancer properties. Further, it has been reported that curcumin may even sensitize cancer cells and make them more susceptible to H₂O₂-induced oxidative stress by downregulating the protective anti-oxidative enzyme glutathione peroxidase, and inducing apoptosis via caspase activity and release of cytochrome C [Mahakunakorn, P., et al., Cytoprotective and cytotoxic effects of curcumin: dual action on H₂O₂-induced oxidative cell damage in NG108-15 cells. Biol Pharm Bull, 2003. 26(5): p. 725-8.]. Therefore, while SH-SY5Y is a well-established model for axon regeneration, it may not be suitable to assess the potential of curcumin to protect against oxidative damage. Therefore, the same assay was repeated on J774 murine macrophages, a non-cancerous immortalized cell line, which has important functions to facilitate successful PNR following PNI. FIG. 15 demonstrates that there is some degree of protection against oxidative stress when J774 cells are treated with 10 μM of Cur-TA-PVP NPs. This not only provides some evidence for the speculation that the NPs exhibited anti-cancer effects on SH-SY5Y cells, but also that the treatment can provide some degree of protection against H₂O₂-induced oxidative stress in normal cells.

### Example 11: A Composition Containing Creatine—an Example of a Nutraceutical Active Ingredient

Synthesis protocol: 0.040 g of creatine and 0.018 g of tannic acid are dissolved in 10 ml of Ethanol (95% v/v). In a separate vial, 0.01 g of PVP is dissolved in 15 mL of DI water. The tannic acid solution is added dropwise into the PVP solution under magnetic stirring (˜650 rpm). The resulting suspension is then dialyzed in a 2 kDa cellulose membrane against 200 mL of water and ethanol in a 6:4 volume ratio. The dialyzed suspension is then centrifuged at 12,000 rpm for 60 mins and resuspended in deionized water.

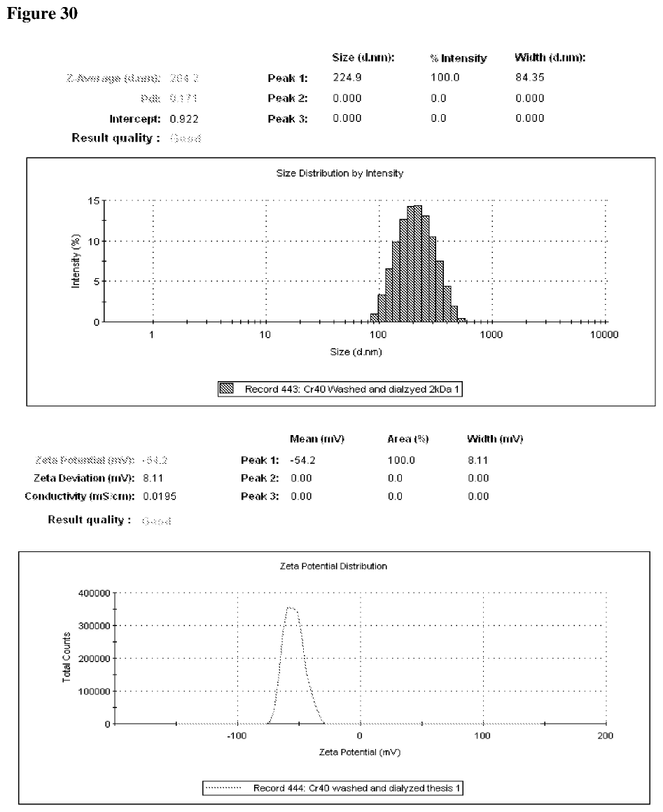

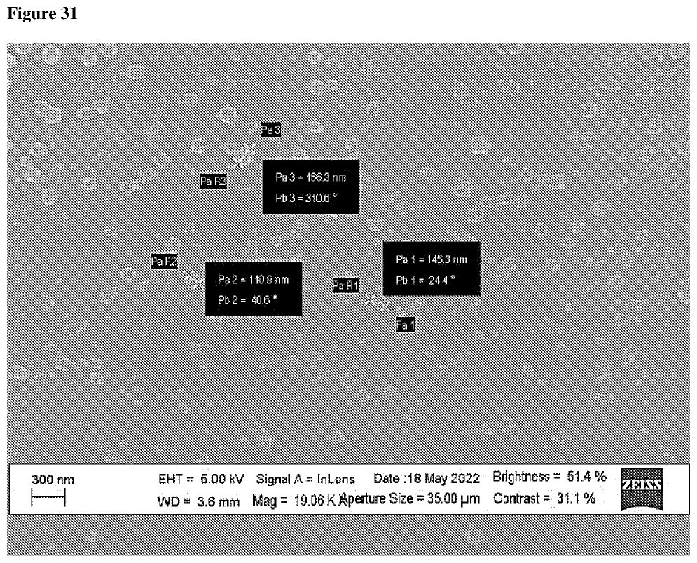

Particle size distributions and SEM images of TA-PVP-Creatine nanoparticles are found in FIGS. 30 and 31.

### INCORPORATION BY REFERENCE

The entire contents of all patents, published patent applications and other references cited herein are hereby expressly incorporated herein in their entirety by reference.

### LIST OF REFERENCES

1. Le, Z., Chen, Y., Han, H., Tian, H., Zhao, P., Yang, C., . . . & Chen, Y. (2018). Hydrogen-bonded tannic acid-based anticancer nanoparticle for enhancement of oral chemotherapy. ACS applied materials & interfaces, 10(49), 42186-42197.
2. Lee, H., Bang, J. B., Na, Y. G., Lee, J. Y., Cho, C. W., Baek, J. S., & Lee, H. K. (2021). Development and Evaluation of Tannic Acid-Coated Nanosuspension for Enhancing Oral Bioavailability of Curcumin. Pharmaceutics, 13(9), 1460.
3. Hatami, E., Bhusetty Nagesh, P. K., Chowdhury, P., Elliot, S., Shields, D., Chand Chauhan, S., . . . & Yallapu, M. M. (2019). Development of zoledronic acid-based nanoassemblies for bone-targeted anticancer therapy. ACS Biomaterials Science & Engineering, 5(5), 2343-2354.
4. Luo, D., Zhang, T., & Zhitomirsky, I. (2016). Electrophoretic deposition of tannic acid—polypyrrolidone films and composites. Journal of colloid and interface science, 469, 177-183.
5. Makkar, H. P. S., Blümmel, M., & Becker, K. (1995). Formation of complexes between polyvinyl pyrrolidones or polyethylene glycols and tannins, and their implication in gas production and true digestibility in in vitro techniques. British Journal of Nutrition, 73(6), 897-913.
6. Li, M., Wu, L., Zhang, C., Chen, W., & Liu, C. (2019). Hydrophilic and antifouling modification of PVDF membranes by one-step assembly of tannic acid and polyvinylpyrrolidone. Applied Surface Science, 483, 967-978.
7. Nam, H. G., Nam, M. G., Yoo, P. J., & Kim, J. H. (2019). Hydrogen bonding-based strongly adhesive coacervate hydrogels synthesized using poly (N-vinylpyrrolidone) and tannic acid. Soft Matter, 15(4), 785-1791.
8. Fan, H., Wang, L., Feng, X., Bu, Y., Wu, D., & Jin, Z. (2017). Supramolecular hydrogel formation based on tannic acid. Macromolecules, 50(2), 666-676.
9. Nawi, N. I. M., Ong Amat, S., Bilad, M. R., Nordin, N. A. H. M., Shamsuddin, N., Prayogi, S., . . . & Faungnawakij, K. (2021). Development of Polyvinylidene Fluoride Membrane via Assembly of Tannic Acid and Polyvinylpyrrolidone for Filtration of Oil/Water Emulsion. Polymers, 13(6), 976.
10. Al Nakeeb, N., Nischang, I., & Schmidt, B. V. (2019). Tannic Acid-Mediated Aggregate Stabilization of Poly (N-vinylpyrrolidone)-b-poly (oligo (ethylene glycol) methyl ether methacrylate) Double Hydrophilic Block Copolymers. Nanomaterials, 9(5), 662.
11. Zheng, L. Y., Shi, J. M., & Chi, Y. H. (2018). Tannic Acid Physically Cross-Linked Responsive Hydrogel. Macromolecular Chemistry and Physics, 219(19), 1800234.
12. Zhang, A., Xiao, Y., Das, P., Zhang, L., Zhang, Y., Fang, H., . . . & Cao, Y. (2019). Synthesis, dissolution, and regeneration of silver nanoparticles stabilized by tannic acid in aqueous solution. Journal of Nanoparticle Research, 21(7), 1-9.
13. Klébert, S., Károly, Z., Késmárki, A., Domján, A., Mohai, M., Keresztes, Z., & Kutasi, K. (2017). Solvent- and catalysts-free immobilization of tannic acid and polyvinylpyrrolidone onto PMMA surface by DBD plasma. Plasma Processes and Polymers, 14(9), 1600202.
14. Li, M., Wu, L., Zhang, C., Chen, W., & Liu, C. (2019). Hydrophilic and antifouling modification of PVDF membranes by one-step assembly of tannic acid and polyvinylpyrrolidone. Applied Surface Science, 483, 967-978.
15. Gaikwad, A., Hlushko, H., Karimineghlani, P., Selin, V., & Sukhishvili, S. A. (2020). Hydrogen-Bonded, Mechanically Strong Nanofibers with Tunable Antioxidant Activity. ACS applied materials & interfaces, 12(9), 11026-11035.
16. Prymak, O., Grasmik, V., Loza, K., Heggen, M., & Epple, M. (2019). Temperature-induced stress relaxation in alloyed silver—gold nanoparticles (7-8 nm) by in situ x-ray powder diffraction. Crystal Growth & Design, 20(1), 107-115
17. Ristig, S., Prymak, O., Loza, K., Gocyla, M., Meyer-Zaika, W., Heggen, M., . . . & Epple, M. (2015). Nanostructure of wet-chemically prepared, polymer-stabilized silver—gold nanoalloys (6 nm) over the entire composition range. Journal of Materials Chemistry B, 3(23), 4654-4662.
18. Aly, S., Hamza, Z., El-Hashash, M. A. A., Hathout, A. S., Sabry, B. A., Soto, E., & Ostroff, G. (2019). Chemical Remediation of Aflatoxin B1 Using Encapsulated Polyvinylpyrrolidone as an Environmental-friendly Control. Egyptian Journal of Chemistry, 62(10), 1933-1947.
19. Guo, Y., Sun, Q., Wu, F. G., Dai, Y., & Chen, X. (2021). Polyphenol-Containing Nanoparticles: Synthesis, Properties, and Therapeutic Delivery. Advanced Materials, 33(22), 2007356.
20. Lu, R., Zhang, X., Cheng, X., Zhang, Y., Zan, X., & Zhang, L. (2020). Medical Applications Based on Supramolecular Self-Assembled Materials From Tannic Acid. Frontiers in Chemistry, 8, 871.
21. Kim, B. J., Cho, H., Park, J. H., Mano, J. F., & Choi, I. S. (2018). Strategic advances in formation of cell-in-shell structures: From syntheses to applications. Advanced Materials, 30(14), 1706063.
22. Kozlovskaya, V., Kharlampieva, E., Drachuk, I., Cheng, D., & Tsukruk, V. V. (2010). Responsive microcapsule reactors based on hydrogen-bonded tannic acid layer-by-layer assemblies. Soft Matter, 6(15), 3596-3608.
23. Liu Zhijia, Le Zhicheng, Chen Yongming, Liu Lixin, Liang Jinrong, & Mao Haiquan. (2019). A drug-loaded nanoparticle based on tannic acid and its preparation method and application (World Intellectual Property Organization Patent No. WO2019137005A1).
24. Jiheung Kim, Hyunkyun Nam, & Jongryeol Moon. (2020). Adhesive polymer composite containing tannic acid and method for producing the same (Patent No. KR102082219B1).
25. Ye Mengqi, He Huacheng, Wu Jiang, Liao Yuping, & Dong Weifei. (2020). Layer-by-layer self-assembled film and its preparation method (China Patent No. CN111714285A).
26. Zhao Zhichao, Zhang Xue, Wang Peixin, & Jin Zhimin. (2019). A composite emulsifier and its preparation method (China Patent No. CN109758968A).
27. Oldenburg, S. J., Miranda, M., Sebba, D. S., & Harris, T. J. (2020). Silver nanoplate compositions and methods (United States Patent No. US20200306294A1). 28. Omidian, H., Qiu, Y., Yang, S., Kim, D., Park, H., & Park, K. (2005). Hydrogels having enhanced elasticity and mechanical strength properties (U.S. Pat. No. 6,960,617B2).
29. Jiheung Kim, Hyunkyun Nam, & Jongryeol Moon. (2020). Adhesive polymer composite containing tannic acid and method for producing the same (Patent No. KR102082219B1).

### EQUIVALENTS

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

Those skilled in the art will recognize, or be able to ascertain using no more than routine experimentation, many equivalents to the specific embodiments and methods described herein. Such equivalents are intended to be encompassed by the scope of the following claims.

It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. An intermolecularly-fabricated composition comprising one or more active ingredients, a polyphenol component and a polymeric stabilizer wherein the polyphenol component and the polymeric stabilizer capture the active ingredient in a chemical matrix.

2. The intermolecularly-fabricated composition according to claim 1, wherein the active ingredient is an agrochemical, a fertilizer, a biostimulant, a pesticide, a pharmaceutical, a reactive chemical products, a food product, a beverage product, or combinations thereof.

3. The intermolecularly-fabricated composition according to claim 2, wherein the active ingredient is a urea compound, a silicon compound, or a polyphenol compound.

4. The intermolecularly-fabricated composition according to claim 2, wherein the active ingredient is oxytetracycline.

5. The intermolecularly-fabricated composition according to claim 2, wherein the active ingredient is curcumin, creatine or dopamine, or a combination thereof.

6. The intermolecularly-fabricated composition according to claim 2, wherein the active ingredient is caffeine, a food or beverage stabilizing agent, a food or beverage flavoring agent, or a combination thereof.

7. The intermolecularly-fabricated composition according to claim 1, wherein the polyphenol component is a flavonoid, a flavone, a flavonol, a flavanol, a flavanone, an isoflavone, a proanthocyanidin, a anthocyanin, a phenolic acid, a phenolic amine, a stilbene, a lingnian, or a combination thereof.

8. The intermolecularly-fabricated composition according to claim 7, wherein the polyphenol component is tannic acid, catechin, hesperetin (, cyanidin, daidzein, quercetin, caffeic acid, reservatrol, ellagic acid, or a combination thereof.

9. The intermolecularly-fabricated composition according to claim 8, wherein the polyphenol component is tannic acid.

10. The intermolecularly-fabricated composition according to claim 1, wherein the polymeric stabilizer is a thermoplastic polymer, a biodegradeable polymer, a hydrophobic polymer, a hydrophilic polymer, a co-polymer consisting of hydrophobic and hydrophilic components, or a combination thereof.

11. A method of stabilizing an active ingredient comprising capturing the active ingredient in an intermolecularly-fabricated composition comprising the active ingredient, a polyphenol component and a polymeric stabilizer to form a formulated active ingredient and storing the formulated active ingredient in a storage medium;
wherein the polyphenol component and the polymeric stabilizer capture the active ingredient in a chemical matrix.

12. The method of stabilizing an active ingredient according to claim 11, wherein the active ingredient is an agrochemical, a fertilizer, a biostimulants, a pesticide, a pharmaceutical, a reactive chemical products, a food product, a beverage product, or combinations thereof.

13. A method of increasing the shelf-life of an active ingredient comprising capturing the active ingredient in an intermolecularly-fabricated composition comprising the active ingredient, a polyphenol component and a polymeric stabilizer to form a formulated active ingredient and storing the formulated active ingredient in a storage medium;
wherein the polyphenol component and the polymeric stabilizer capture the active ingredient in a chemical matrix such that the shelf-life of the active ingredient is increased by at least two months as compared to a non-formulated form of the same active ingredient in the same storage medium.

14. The method of increasing the shelf-life of an active ingredient according to claim 13, wherein the active ingredient is an agrochemical, a fertilizer, a biostimulants, a pesticide, a pharmaceutical, a reactive chemical products, a food product, a beverage product, or combinations thereof.

15. A method of delivering an active ingredient to a subject, the method comprising:
capturing the active ingredient in an intermolecularly-fabricated composition comprising the active ingredient, a polyphenol component and a polymeric stabilizer;
and administering the intermolecularly-fabricated composition to the subject.

16. The method of delivering an active ingredient to a subject according to claim 15, further comprising a step of formulating the intermolecularly-fabricated composition with one or solvents, carriers, adjuvants, or excipients acceptable for administration to the subject.

17. The method of delivering an active ingredient to a subject according to claim 15, wherein the active ingredient is an agrochemical, a fertilizer, a biostimulant, a pesticide, a pharmaceutical, a reactive chemical products, a food product, a beverage product, or combinations thereof.

18. The method of delivering an active ingredient to a subject according to claim 15, wherein the subject is a human, an animal, a plant-based organism, a food product, or a beverage product.
